(19) United States
(12) Patent Application Publication
(10) Pub. No.: US 2013/0149678 A1
(43) Pub. Date: Jun. 13, 2013

(54) SYSTEM AND METHODS FOR VIRTUAL COOKING WITH MULTI-COURSE PLANNING

(71) Applicants: Yukie J. Tokuda, Redwood City, CA (US); Josiah A. Slone, Campbell, CA (US); Michael A. Vyvoda, Redwood City, CA (US); Robert S. Vachalek, Cupertino, CA (US)

(72) Inventors: Yukie J. Tokuda, Redwood City, CA (US); Josiah A. Slone, Campbell, CA (US); Michael A. Vyvoda, Redwood City, CA (US); Robert S. Vachalek, Cupertino, CA (US)

(21) Appl. No.: 13/323,535

(22) Filed: Dec. 12, 2011

(51) Int. Cl. G09B 19/00

(52) U.S. Cl. 434/127

(57) ABSTRACT

Methods for generating recipe recommendations based on virtual cooking results from a virtual cooking system are described. In some embodiments, a virtual cooking result is generated based on a recipe for making a particular food or beverage. The virtual cooking result may include quantitative representations of various expected characteristics of the particular food or beverage. For example, the virtual cooking result may include resulting ingredients, resulting volatile aromatic compounds, and estimates regarding one or more flavors associated with the particular food or beverage. The generation of different virtual cooking results associated with different recipes allows computer programs to leverage machine learning techniques and solve optimization problems in order to determine an optimum recipe or set of recipes for a given set of recipe constraints. The recipe recommendations may include recipe pairing recommendations, multi-meal recipe recommendations, and new recipes optimized to satisfy a particular flavor profile.

### BACKGROUND

Cookbooks typically include a collection of recipes along with other information regarding the preparation and cooking of food. The recipes in a cookbook may be categorized according to the type of food (e.g., seafood, desserts, or beverages), cooking methods used (e.g., grilling or baking), key ingredients (e.g., chicken or beef), or recipe complexity (e.g., quick and easy recipes). A recipe may include a list of one or more ingredients and an associated set of instructions for preparing or making a particular food or beverage. Other information associated with the recipe may include pictures of various phases of the preparation process, estimates of the preparation and cooking times, and suggestions regarding possible ingredient and/or cooking method substitutions.

The Internet may provide access to recipes stored in a digital format on a remote server. The digital recipes may be searched or filtered according to various matching criteria such as particular ingredients, particular cooking methods, or particular nutritional constraints such as calories per serving.

### BRIEF DESCRIPTION OF THE DRAWINGS

FIG. 1 is a block diagram of one embodiment of a networked computing environment in which the disclosed technology may be practiced.

FIG. 2 depicts one embodiment of a set of recipe recommendations as displayed on a mobile device.

FIG. 3A depicts one embodiment of a virtual cooking server.

FIG. 3B depicts one embodiment of a VCR database.

FIG. 3C depicts one embodiment of a virtual cooking system.

FIG. 3D depicts one embodiment of a virtual cooking appliance.

FIG. 3E depicts one embodiment of a flavor predictor.

FIG. 3F depicts one embodiment of a food and beverage recommendations system.

FIG. 4A is a flowchart describing one embodiment of a process for generating one or more recipe recommendations.

FIG. 4B is a flowchart describing one embodiment of a process for acquiring a personal recipe profile.

FIG. 5A is a flowchart describing one embodiment of a process for generating a recipe graph based on a recipe.

FIG. 5B is a flowchart describing one embodiment of a process for generating a canonical recipe graph.

FIG. 6A depicts one embodiment of a recipe.

FIG. 6B depicts one embodiment of a recipe graph associated with the recipe of FIG. 6A.

FIG. 6C depicts one embodiment of a recipe graph after node reduction and the addition of missing steps or ingredients have been performed on the recipe graph of FIG. 6B.

FIG. 6D depicts one embodiment of a recipe graph after node substitution has been performed on the recipe graph of FIG. 6C.

FIG. 7A is a flowchart describing one embodiment of a process for generating a virtual cooking result based on a recipe graph.

FIG. 7B is a flowchart describing one embodiment of a process for generating a VCR based on a particular cooking step and one or more inputs.

FIG. 7C depicts one embodiment of a taste values matrix.

FIG. 7D depicts one embodiment of a function for determining a saltiness value given input ingredients.

FIG. 7E depicts one embodiment of a categorized aromatic values matrix.

FIG. 7F depicts one embodiment of a mouthfeel values matrix.

FIG. 8A is a flowchart describing one embodiment of a process for generating a first set of resulting ingredient properties and a second set of resulting VAC properties.

FIG. 8B depicts one embodiment of a standardized ingredients matrix.

FIG. 8C depicts one embodiment of a standardized VACs matrix.

FIG. 8D depicts one embodiment of a standardized cooking methods matrix.

FIG. 8E is a flowchart describing one embodiment of a process for generating one or more flavor metrics.

FIG. 9A is a flowchart describing one embodiment of a process for generating recipe pairings.

FIG. 9B is a flowchart describing an alternative embodiment of a process for generating recipe pairings.

FIG. 9C is a flowchart describing one embodiment of a process for generating recipe pairings.

FIG. 9D is a flowchart describing one embodiment of a process for generating multi-meal recipe recommendations.

FIG. 9E depicts one embodiment of five specific recipe constraints associated with five different meals.

FIG. 9F is a flowchart describing one embodiment of a process for generating recipe recommendations.

FIG. 9G is a flowchart describing an alternative embodiment of a process for generating recipe recommendations.

FIG. 10 is a block diagram of one embodiment of a mobile device.

FIG. 11 is a block diagram of an embodiment of a computing system environment.

### DETAILED DESCRIPTION

Technology is described for generating recipe recommendations based on virtual cooking results from a virtual cooking system. In some embodiments, a virtual cooking result is generated based on a recipe for making a particular food or beverage. The virtual cooking result may include quantitative representations of various expected characteristics of the particular food or beverage. For example, the virtual cooking result may include resulting ingredients, resulting volatile aromatic compounds, and estimates regarding one or more flavors associated with the particular food or beverage. The generation of different virtual cooking results associated with different recipes allows computer programs to leverage machine learning techniques and solve optimization problems in order to determine an optimum recipe or set of recipes for a given set of recipe constraints. The recipe recommendations may include recipe pairing recommendations, multi-meal recipe recommendations, and new recipes optimized to satisfy a particular flavor profile.

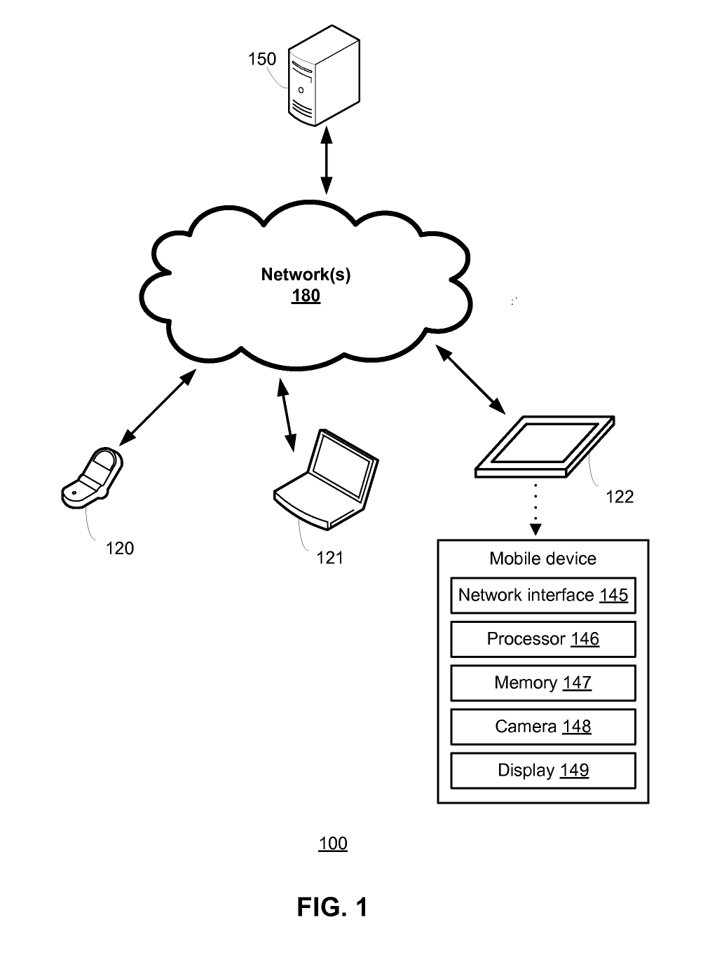

FIG. 1 is a block diagram of one embodiment of a networked computing environment 100 in which the disclosed technology may be practiced. Networked computing environment 100 includes a plurality of computing devices interconnected through one or more networks 180. The one or more networks 180 allow a particular computing device to connect to and communicate with another computing device. The depicted computing devices include mobile devices 120-122 and virtual cooking server 150. In some embodiments, the plurality of computing devices may include other computing devices not shown such as non-mobile computing devices. In some embodiments, the plurality of computing devices may include more than or less than the number of computing devices shown in FIG. 1. The one or more networks 180 may include a secure network such as an enterprise private network, an unsecure network such as a wireless open network, a local area network (LAN), a wide area network (WAN), and the Internet. Each network of the one or more networks 180 may include hubs, bridges, routers, switches, and wired transmission media such as a wired network or direct-wired connection.

A server, such as virtual cooking server 150, may allow a client to download information (e.g., text, audio, image, and video files) from the server or to perform a search query related to particular information stored on the server. In general, a “server” may include a hardware device that acts as the host in a client-server relationship or a software process that shares a resource with or performs work for one or more clients. Communication between computing devices in a client-server relationship may be initiated by a client sending a request to the server asking for access to a particular resource or for particular work to be performed. The server may subsequently perform the actions requested and send a response back to the client.

One embodiment of mobile device 122 includes a camera 148, display 149, network interface 145, processor 146, and memory 147, all in communication with each other. Camera 148 may capture digital images and/or videos. Camera 148 may comprise a back-facing or a front-facing camera. Display 149 may display digital images and/or videos. Network interface 145 allows mobile device 122 to connect to one or more networks 180. Network interface 145 may include a wireless network interface, a modem, and/or a wired network interface. Processor 146 allows mobile device 122 to execute computer readable instructions stored in memory 147 in order to perform processes discussed herein.

Networked computing environment 100 may provide a cloud computing environment for one or more computing devices. Cloud computing refers to Internet-based computing, wherein shared resources, software, and/or information are provided to one or more computing devices on-demand via the Internet. The term “cloud” is used as a metaphor for the Internet, based on the cloud drawings used in computer network diagrams to depict the Internet as an abstraction of the underlying infrastructure it represents.

In one embodiment, a computing device receives one or more recipes from the virtual cooking server 150 based on a set of recipe constraints. The set of recipe constraints may require that each recipe of the one or more recipes satisfies a flavor profile. The flavor profile may include quantitative characterizations of various tastes (e.g., saltiness, sweetness, or sourness) via one or more taste values and quantitative characterizations of various aromas (e.g., fruity smells or floral smells) via one or more aromatic values. The one or more taste values may represent a taste vector and the one or more aromatic values may represent an aromatic vector. Most flavors perceived by a human when consuming a food or beverage come from the volatile aromatic compounds (VACs) sensed by the human. The VACs may be released from food either naturally (e.g., stinky cheese) or during chewing of the food. The flavor profile may also include a quantitative characterization of the total flavor intensity of a food or beverage.

The set of recipe constraints may also require that each recipe of the one or more recipes include a particular ingredient (e.g., broccoli) or cooking step (e.g., baking). Other recipe constraints may require that each recipe of the one or more recipes uses less than a maximum number of ingredients or takes less than a maximum amount of time to prepare and cook. The one or more recipes may include recipe pairing recommendations, multi-meal recipe recommendations, and new recipes optimized to satisfy a particular flavor profile specified by an end user of the computing device.

In some embodiments, the virtual cooking server 150 may receive a recipe and generate a virtual cooking result (VCR) associated with the recipe. The virtual cooking result or VCR may include quantitative characterizations regarding the expected flavor of the recipe including, for example, the degree of saltiness, the intensity of a particular aroma, and the expected total flavor intensity of the recipe. The quantitative characterizations may be transmitted to a mobile device such as mobile device 122 and displayed on display 149. The ability to view the expected flavor characteristics of a recipe allows an end user of mobile device 122 to experiment with many different recipes and to virtually cook a recipe in order to determine the expected flavor of the recipe without having to actually cook the recipe.

In one embodiment, the virtual cooking server 150 may generate one or more recipe recommendations based on information regarding the availability of various foods. In some cases, the food availability information may be received from one or more intelligent food storing appliances such as an intelligent refrigerator or an intelligent food pantry. The one or more intelligent food storing appliances may store various foods and/or beverages and track the various foods and/or beverages stored over time. The tracking of foods may be performed using radio-frequency identification (RFID) tags located on food containers within the intelligent food storing appliances. An intelligent food storing appliance may also acquire and process images of the food containers located within the food storing appliance (e.g., using pattern and object recognition techniques) in order to identify and track the various foods located within the food storing appliance over time. An intelligent food storing appliance may also use pressure sensors to detect the presence of various foods such as a carton of eggs or a gallon of milk existing within predetermined locations within the intelligent food storing appliance. In some embodiments, the virtual cooking server 150 may indirectly track the amount of food contained within the one or more intelligent food storing appliances over time by tracking the total amount of food purchased over time (e.g., by tracking the groceries purchased using an online grocery delivery service), determining the amount of food used when cooking or preparing various meals (e.g., by looking up the amount of food used to cook various recipes), and subtracting the amount of food used over time from the total amount of food purchased.

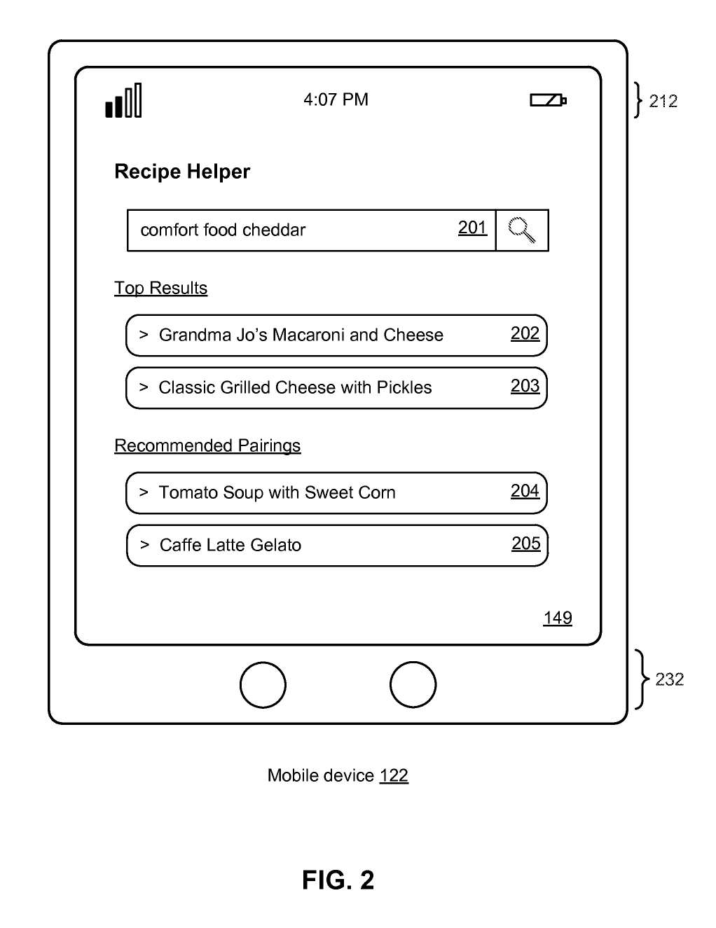

FIG. 2 depicts one embodiment of a set of recipe recommendations 202-205 as displayed on mobile device 122. As depicted, mobile device 122 includes a touchscreen display 149 and physical control buttons 232. The touchscreen display 149 may include an LCD display. The touchscreen display 149 includes a status area 212 which provides information regarding signal strength, time, and battery life associated with the mobile device 122. Each of the recipe recommendations 202-203 may satisfy one or more recipe constraints provided by an end user of mobile device 122 via a search query field 201. The recipe recommendations 202-203 may be associated with the top two most popular recipes that satisfy the one or more recipe constraints provided by the end user. The recipe recommendations 204-205 may comprise recommended recipe pairings associated with either one or both of recipe recommendations 202-203. An end user of mobile device 122 may select and access additional information regarding a particular recipe of the set of recipe recommendations 202-205 by selecting the particular recipe using the touchscreen display 149.

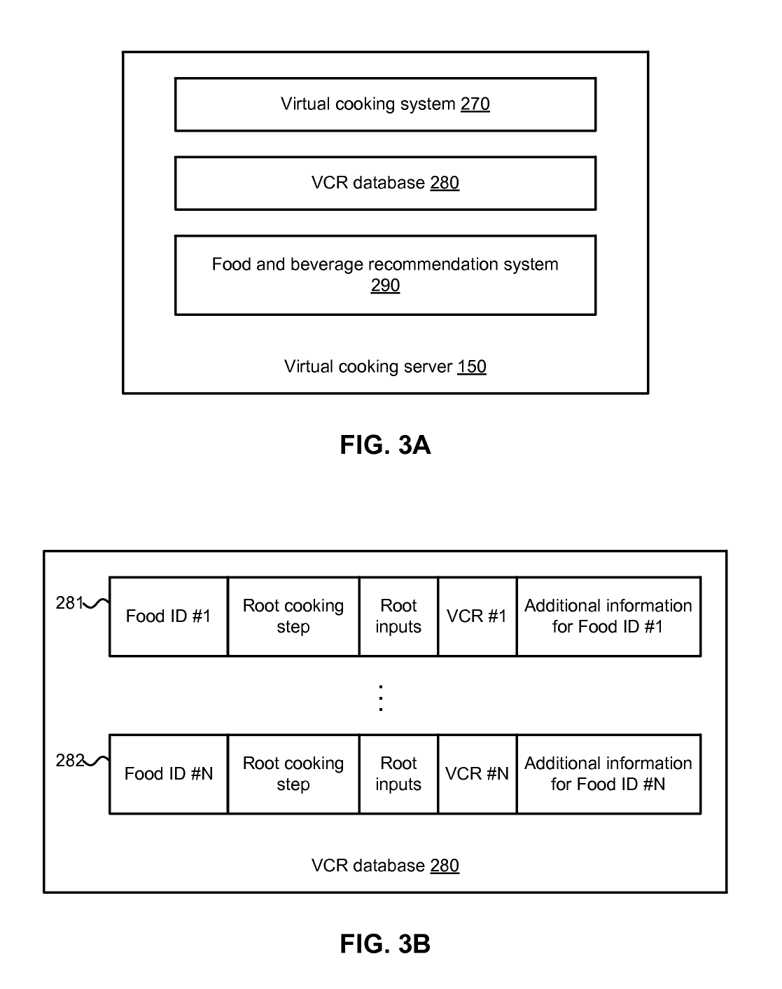

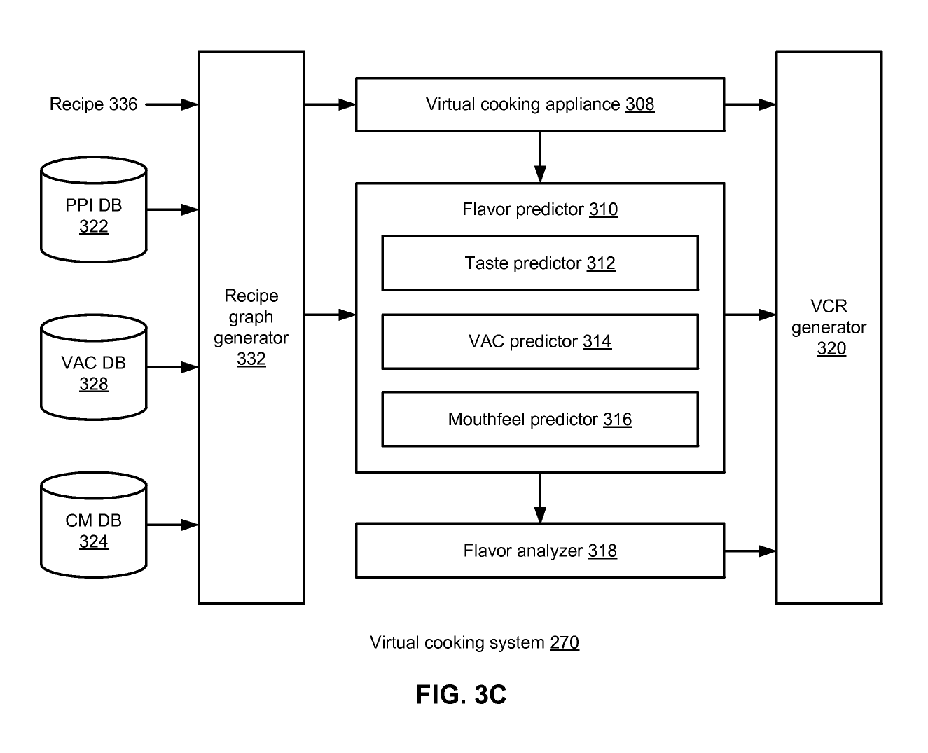

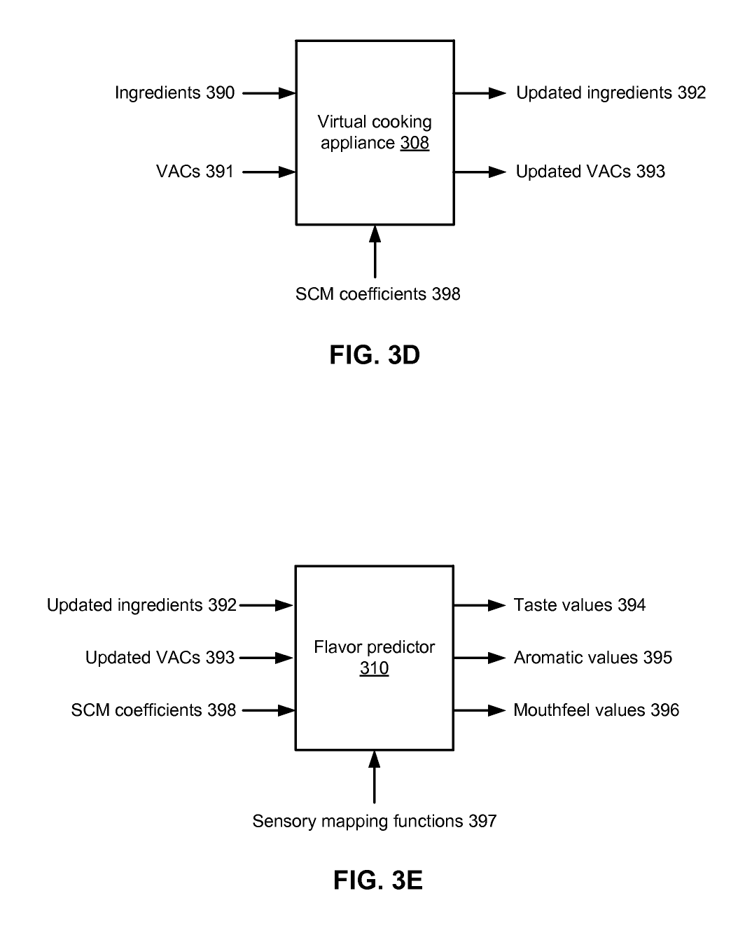

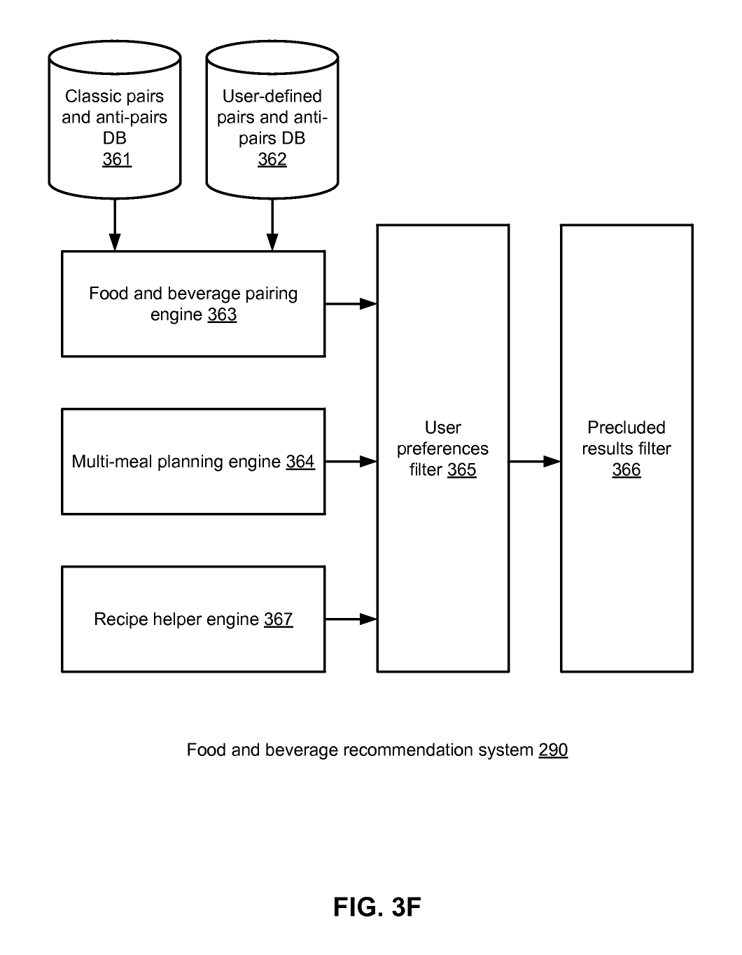

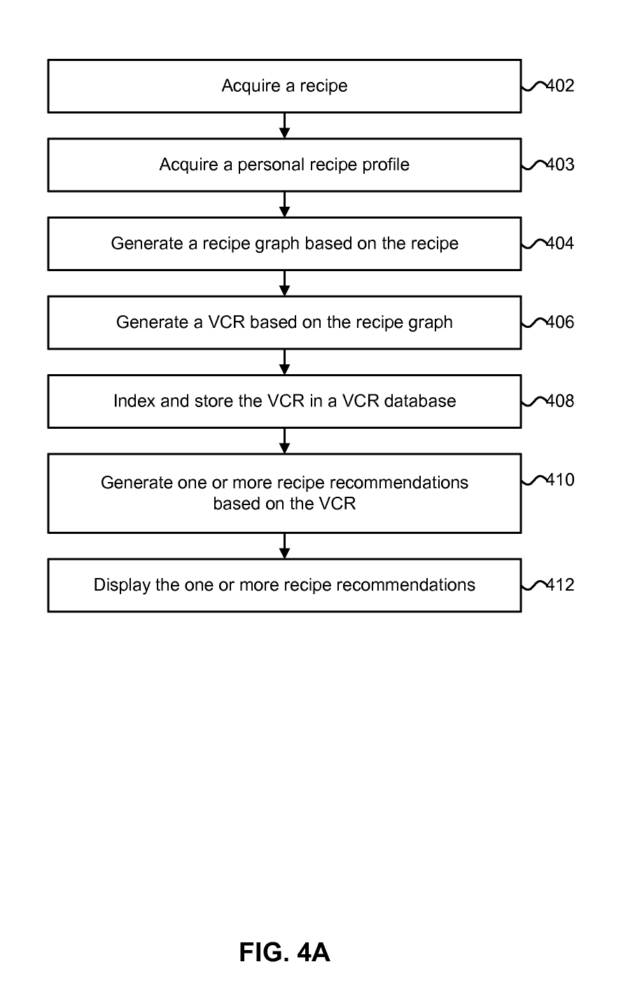

FIG. 3A depicts one embodiment of a virtual cooking server 150. Virtual cooking server 150 includes a virtual cooking system 270, a VCR database 280, and a food and beverage recommendation system 290, all in communication with each other. The virtual cooking system 270 may generate a VCR based on an inputted recipe. The VCR database 280 may store one or more VCRs generated by the virtual cooking system 270. The food and beverage recommendation system 290 may generate one or more recipe recommendations based on the one or more VCRs stored within VCR database 280. In some embodiments, a virtual cooking server may be included locally within a mobile computing device, such as mobile device 122 in FIG. 1.

FIG. 3B depicts one embodiment of a VCR database 280. As depicted, VCR database 280 includes a first VCR entry 281 and a second VCR entry 282. The first VCR entry 281 includes various fields including a unique food identifier (Food ID #1), a root cooking step (i.e., the last cooking step of the recipe associated with the VCR entry), one or more root inputs (i.e., the input ingredients or intermediate cooking results of the recipe that are used as inputs to the root cooking step), a virtual cooking result (VCR #1), and additional information associated with the recipe corresponding with the VCR entry. The additional information may include information regarding the source of the recipe (e.g., a particular person from which the recipe was obtained or a particular cookbook from which recipe was obtained), the country of origin associated with the recipe, the recipe title, estimated preparation time, the number of “likes” or other popularity measure associated with the recipe, or the food category assigned to the recipe (e.g., a dessert or appetizer). The additional information may also include nutritional information (e.g., a low-fat or low-sodium recipe) and/or flavor information (e.g., a salty or sweet tasting recipe) associated with the recipe. The nutritional information and flavor information may be automatically generated based on the virtual cooking result and may be stored as searchable metadata tags or labels associated with the first VCR entry 281. In some cases, the one or more root inputs may include one or more pointers to VCR entries within the VCR database 280 associated with input ingredients or intermediate cooking results of the recipe. The VCR database 280 may be stored in non-volatile memory within the virtual cooking server 150.

In one embodiment, each of the one or more root inputs (e.g., the intermediate cooking results that are used as inputs to the root cooking step) may be associated with a corresponding VCR entry in the VCR database 280. In some cases, intermediary VCR entries associated with intermediate cooking results generated by a virtual cooking system, such as virtual cooking system 270 in FIG. 3A when generating an ultimate virtual cooking result, may be stored in VCR database 280. For example, a baked macaroni recipe may include a root cooking step of baking the combination of cooked macaroni and a particular mixture. Both the cooked macaroni and the particular mixture (e.g., a mixture of eggs, evaporated milk, and Tabasco® sauce) may be associated with corresponding VCR entries in the VCR database 280.

In some embodiments, metadata tags may be automatically generated once a new VCR entry is added to the VCR database 280. The metadata tags may be related to nutritional information or flavor information associated with the new VCR entry (e.g., that a particular recipe associated with the new VCR entry is a low-fat recipe or a sweet tasting recipe). Once the metadata tags have been generated and attached to the new VCR entry, subsequent search and retrieval of the new VCR entry may be performed based on the metadata tags. In one example, all VCR entries labeled as appetizers and tagged as being low-fat and sweet tasting recipes may be retrieved by a food and beverage recommendation system, such as food and beverage recommendation system 290 in FIG. 3A. In another example, all VCR entries within a VCR database, such as VCR database 280 in FIG. 3A, satisfying a particular flavor profile and tagged as being low-fat recipes may be searched for and retrieved.

FIG. 3C depicts one embodiment of a virtual cooking system 270. As depicted, virtual cooking system 270 includes a recipe graph generator 332, a virtual cooking appliance 308, a flavor predictor 310, a flavor analyzer 318, and a VCR generator 320, all in communication with each other. The flavor predictor 310 includes a taste predictor 312, a volatile aromatic compound (VAC) predictor 314, and a mouthfeel predictor 316. The virtual cooking system 270 also includes a physical properties of ingredients database (PPI DB) 322, a volatile aromatic compounds database (VAC DB) 328, and a cooking methods database (CM DB) 324, all in communication with the recipe graph generator 332.

The recipe graph generator 332 generates a recipe graph associated with an input recipe 336. The input recipe 336 may include one or more ingredients and one or more cooking steps. The recipe graph may include a root cooking node associated with the last cooking step of the input recipe 336, leaf nodes associated with input ingredients of the input recipe 336, and other nodes associated with the other cooking steps associated with the input recipe 336. The recipe graph may be optimized by merging redundant nodes or cooking steps into a single node and substituting one or more nodes within the recipe graph with a simplified node associated with a predetermined cooking result.

The physical properties of ingredients database 322 of FIG. 3C may be used to convert ingredient amounts specified as volume unit measurements into a corresponding mass or weight. The physical properties of ingredients database 322 may store density information and/or volume to weight mappings associated with a large number of ingredients. For example, volume to weight mappings may include mappings such as one tablespoon of water weighs 14.79 grams, 1 tablespoon of salt weighs 18.25 grams, or 1 tablespoon of butter weighs 14.19 grams. The physical properties of ingredients database 322 may also be used to convert ingredient amounts specified as a variable natural quantity, such as a whole onion or a large egg, into a corresponding mass or weight by using a lookup table of standardized natural quantities. For example, a large-sized egg may map to a mass of 70 grams and a medium-sized egg may map to a mass of 55 grams.

The volatile aromatic compounds database 328 of FIG. 3C may be used to convert input ingredients and their respective masses into a list of volatile aromatic compounds associated with the input ingredients. The volatile aromatic compounds database 328 may also predict an aromatic intensity associated with each of the volatile aromatic compounds identified based on the solvent in which the volatile aromatic compound exists and the amount of the input ingredient associated with the volatile aromatic compound. For example, a cup of orange juice may be associated with aromatic compounds including ethyl butyrate, myrcene, and/or limonene. Each aromatic compound may be associated with a particular aroma or smell. However, in order for an aromatic compound to be smelled it must be volatile (i.e., transportable to the olfactory system in the upper part of the nose) and present in a sufficiently high concentration in order to react with the olfactory receptors and be perceived. The volatile aromatic compounds may be released from food naturally (e.g., stinky cheese) or by chewing the food. In some embodiments, only the key (or most significant) aromatic compounds for a particular ingredient may be identified by the volatile aromatic compounds database 328. The key volatile aromatic compounds may comprise key odorants (i.e., the compounds that a person will effectively smell). The volatile aromatic compounds returned by the volatile aromatic compounds database 328 may be filtered by comparing the concentrations of the key volatile aromatic compounds with a particular concentration threshold.

The cooking methods database 324 of FIG. 3C includes sets of cooking method coefficients associated with various standardized cooking processes. Each set of cooking method coefficients is associated with a particular cooking step and the cooking method coefficients may be scaled based on cooking time and temperature associated with the particular cooking step. A cooking step may include, for example, frying, sautéing, baking, grilling, or mixing a particular set of ingredients. The cooking method coefficients provide information regarding what to expect the particular cooking step to produce on a physical and/or chemical level. For example, the cooking method coefficients may include a water loss coefficient (e.g., due to water evaporation), a Maillard reaction (or browning reaction) coefficient, and/or a VAC loss coefficient. The Maillard reaction is the phenomenon responsible for turning meat brown and converting bread to toast. In some embodiments, the cooking methods database 324 may use information associated with the one or more ingredients in order to determine a particular cooking method coefficient. For example, in order to determine the Maillard reaction coefficient, a certain amount of proteins and sugars must be present as input ingredients to the particular cooking step.

As depicted in FIG. 3C, the virtual cooking appliance 308 may receive inputs from the recipe graph generator 332. The inputs received from the recipe graph generator 332 may include one or more ingredients, one or more volatile aromatic compounds, and/or one or more cooking method coefficients associated with a particular cooking step of the recipe graph generated by recipe graph generator 332.

FIG. 3D depicts one embodiment of a virtual cooking appliance 308. As depicted in FIG. 3D, the virtual cooking appliance 308 may receive one or more ingredients 390, one or more volatile aromatic compounds (VACs) 391, and one or more standard cooking method (SCM) coefficients 398. In response, the virtual cooking appliance 308 may output one or more updated ingredients 392 and one or more updated VACs 393. The virtual cooking appliance 308 may virtually cook the one or more ingredients 390 by mapping the one or more ingredients 390 to the one or more updated ingredients 392 based on the one or more SCM coefficients 398. In some embodiments, the outputs of the virtual cooking appliance 308 (e.g., the one or more updated ingredients 392) may be generated using machine learning techniques. The machine learning techniques may use training sets comprising input ingredients, VACs, and SCM coefficients, and their corresponding updated ingredients and VACs in order to generate output values for the virtual cooking appliance 308. In some cases, the machine learning techniques may use neural networks or support vector machines.

As depicted in FIG. 3C, the flavor predictor 310 may receive inputs from the recipe graph generator 332 and the virtual cooking appliance 308. The flavor predictor 310 may use taste predictor 312 to generate one or more taste values. The one or more taste values may include a sweetness value, a sourness value, a bitterness value, a saltiness value, and an umaminess value. Umaminess relates to the savory taste of glutamates and nucleotides. These five taste values represent the five taste components that can be sensed on a biological level by a human. Each of the one or more taste values may represent a particular taste intensity. The flavor predictor 310 may use VAC predictor 314 to generate one or more aromatic values. The one or more aromatic values may include an herbal value, a floral value, a fruity value, a citrus value, and an earthy value. Each of the one or more aromatic values may represent an aroma intensity associated with one or more volatile aromatic compounds. The flavor predictor 310 may use mouthfeel predictor 316 to generate one or more mouthfeel values. The one or more mouthfeel values may include a spiciness value and a temperature value. Mouthfeel refers to the physical sensation that a food may have in a person's mouth. Common mouthfeel sensations include temperature (e.g., is the food hot or cold) and physical irritation of the mouth (e.g., is the food spicy).

FIG. 3E depicts one embodiment of a flavor predictor 310. As depicted in FIG. 3E, the flavor predictor 310 may receive one or more updated ingredients 392, one or more updated VACs 393, one or more SCM coefficients 398, and a set of sensory mapping functions 397. In response, the flavor predictor 310 may output one or more taste values 394, one or more aromatic values 395, and one or more mouthfeel values 396. The sensory mapping functions 397 may map the input ingredients, VACs, and SCM coefficients into estimated flavor values. In some embodiments, the outputs of the flavor predictor 310 (e.g., the one or more taste values 394) may be generated using machine learning techniques. The machine learning techniques may use training sets comprising input ingredients, VACs, and SCM coefficients, and their corresponding taste values, aromatic values, and mouthfeel values in order to generate output values for the flavor predictor 310. In some cases, the machine learning techniques may use neural networks or support vector machines.

As depicted in FIG. 3C, the flavor analyzer 318 may receive flavor estimates from the flavor predictor 310. The flavor analyzer may output one or more flavor metrics associated with one or more taste values, one or more aromatic values, and/or one or more mouthfeel values outputted from the flavor predictor 310. In one example, a flavor metric of the one or more flavor metrics may be associated with a total flavor intensity value. The total flavor intensity value may be calculated using a weighted combination of the one or more taste values and the one or more aromatic values. Other flavor metrics may also be generated including one or more flavor derivative values. In one example, a flavor derivative value associated with the difference between the saltiness and the sweetness of a particular recipe may be calculated by determining a difference between a saltiness value and a sweetness value. In another example, a flavor derivative value may be calculated by determining a difference between a saltiness value and the sum of all other taste values. Flavor derivative values may also be calculated for the one or more aromatic values or between the one or more taste values and the one or more aromatic values. In one example, a flavor derivative value may be calculated by determining a difference between a fruity value and a citrus value. In another example, a flavor derivative may be calculated by determining a difference between a sweetness value and a fruity value.

As depicted in FIG. 3C, the VCR generator 320 may receive inputs from the virtual cooking appliance 308, the flavor predictor 310, and the flavor analyzer 318. The VCR generator 320 may generate a virtual cooking result associated with the input recipe 336. The virtual cooking result may include information regarding the resulting ingredients, the resulting volatile aromatic compounds, the one or more taste values, the one or more aromatic values, the one or more mouthfeel values, and/or the one or more flavor metrics associated with input recipe 336.

FIG. 3F depicts one embodiment of a food and beverage recommendation system 290. As depicted, food and beverage recommendation system 290 includes a food and beverage pairing engine 363, a multi-meal planning engine 364, a recipe helper engine 367, a user preferences filter 365, and a precluded results filter 366, all in communication with each other. The food and beverage recommendation system 290 may acquire one or more virtual cooking results from a VCR database, such as VCR database 280 in FIG. 3A, and generate one or more recipe recommendations based on the one or more virtual cooking results and one or more recipe constraints provided by an end user of a virtual cooking server, such as virtual cooking server 150 in FIG. 3A.

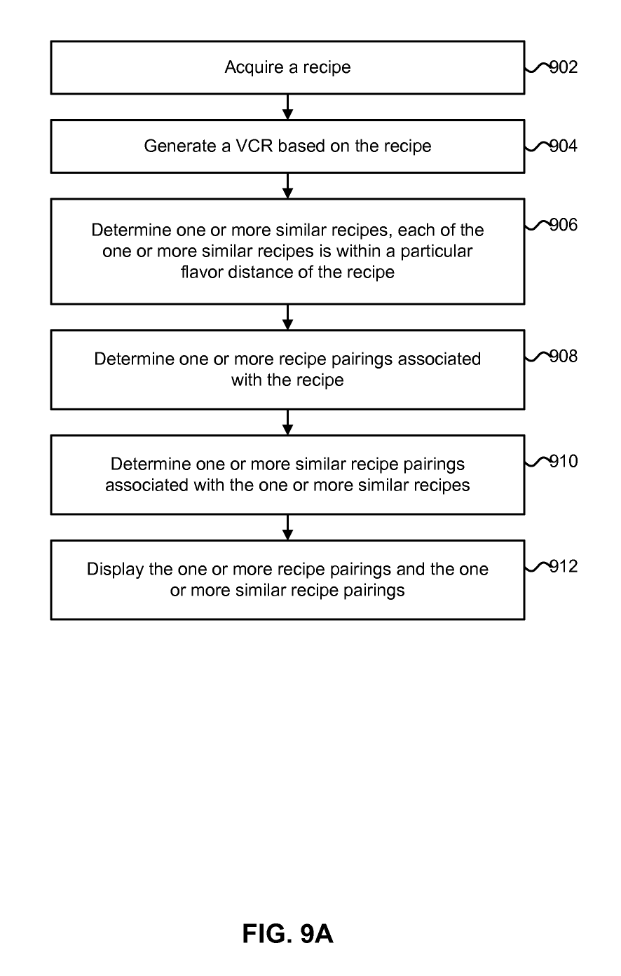

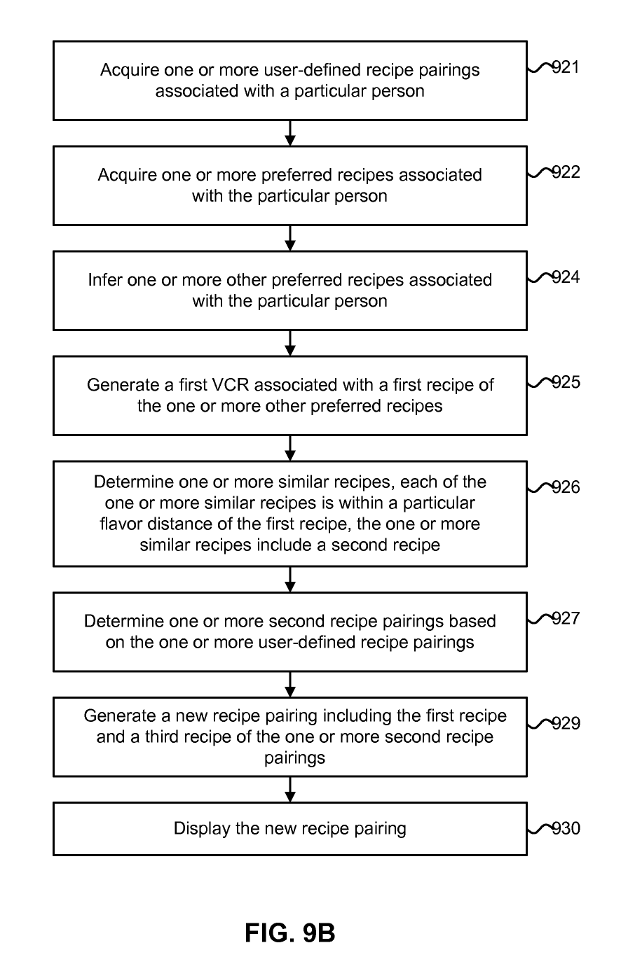

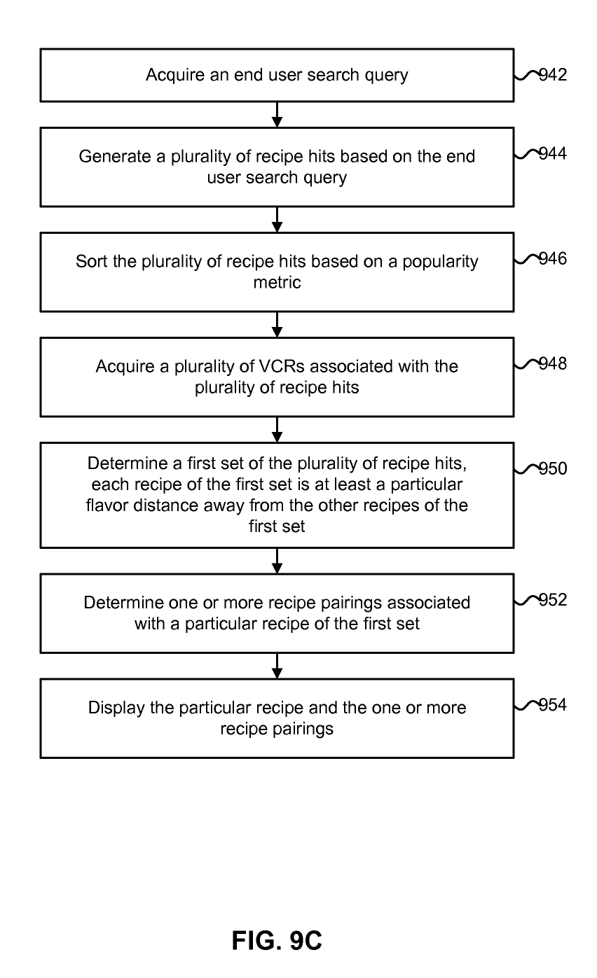

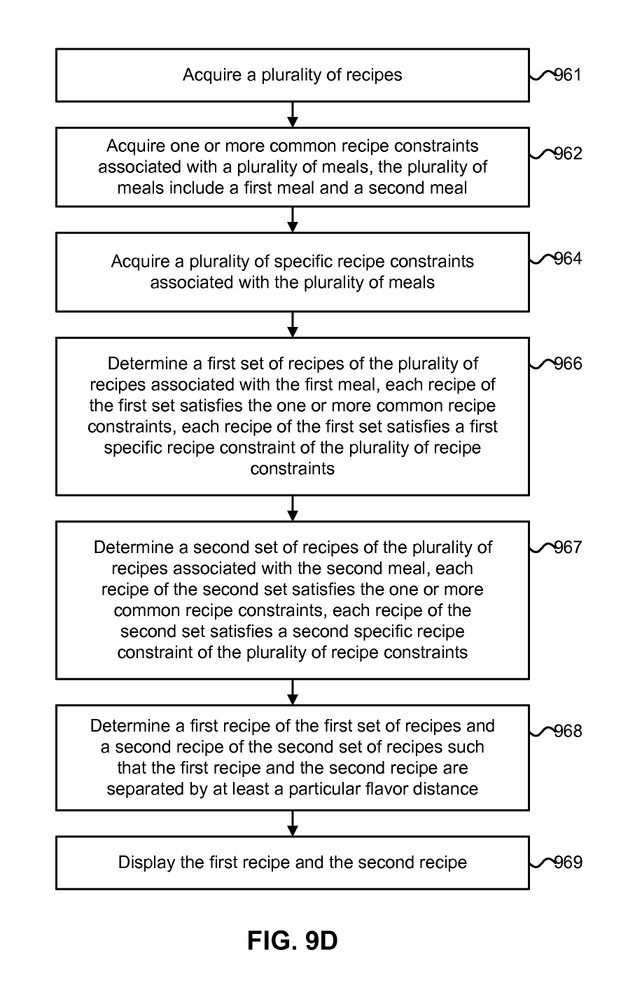

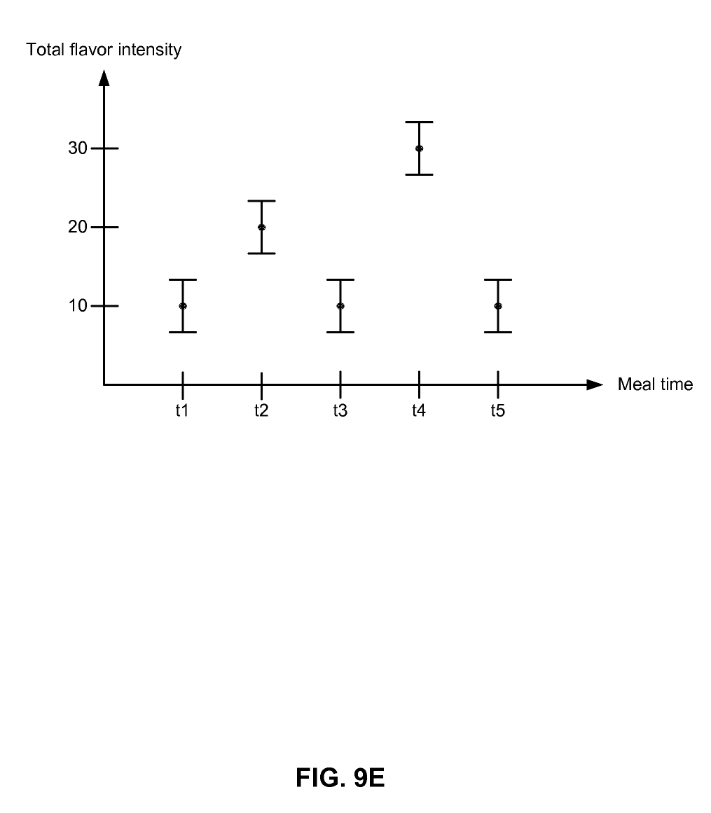

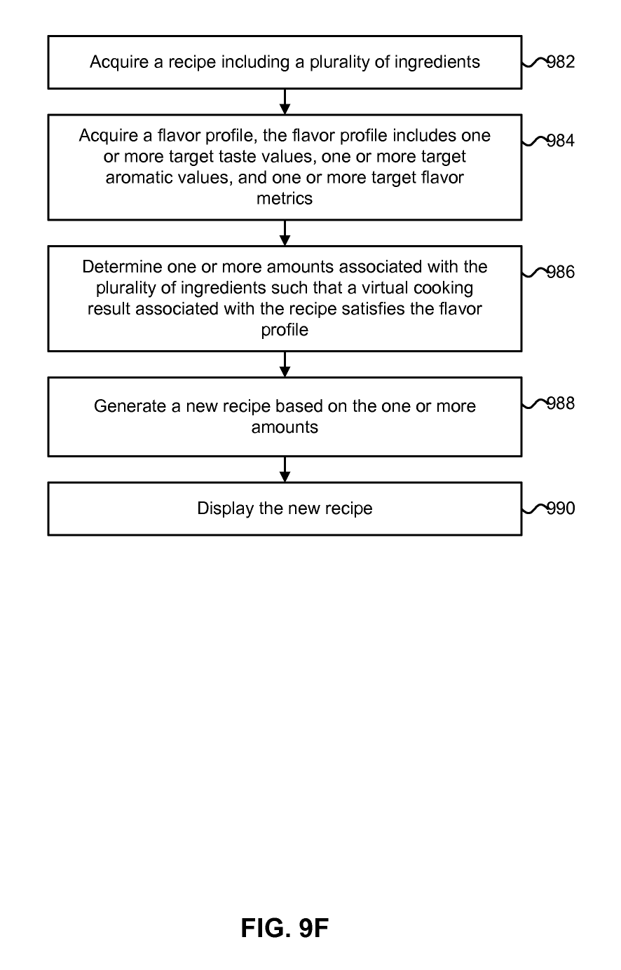

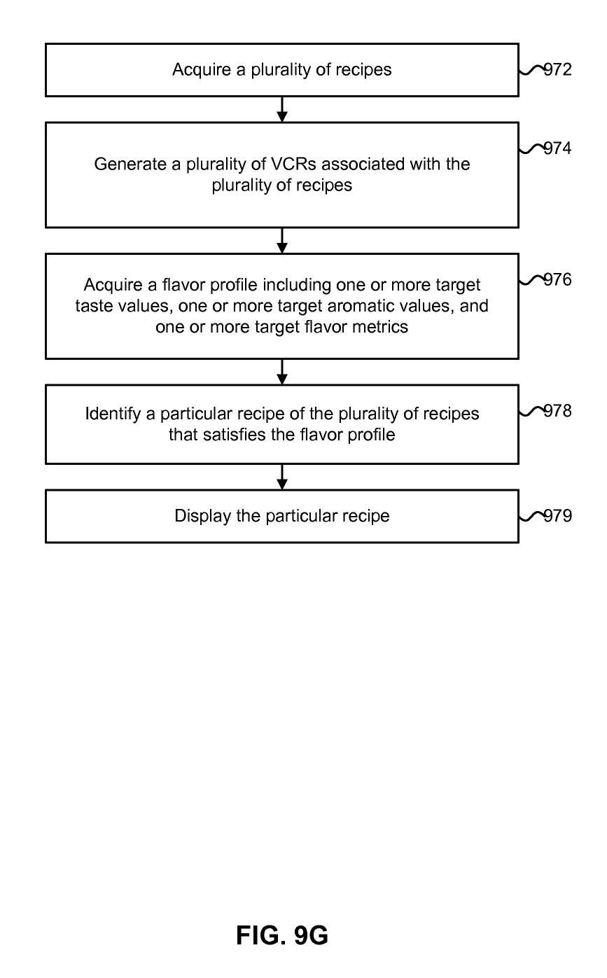

The food and beverage pairing engine 363 of FIG. 3F may acquire pairing information from a classic pairs and anti-pairs database 361 or a user-defined pairs and anti-pairs database 362. The pairing information may include a list of recipes and corresponding pointers to one or more paired recipes (i.e., recipes that are considered to pair well with a particular recipe) for each recipe in the list of recipes. For example, a steak recipe may pair well with a potato recipe and a creamed spinach recipe. Each recipe in the list of recipes may also be associated with one or more anti-pair recipes (i.e., recipes that are considered to not pair well with a particular recipe). The anti-pairing information may be used to preclude the pairing of two recipes (e.g., a spicy sauce recipe should not be paired with a bland fish recipe). In some cases, user-defined recipe pairings from a user-defined pairs and anti-pairs database 362 may be weighed more heavily as compared with classic recipe pairings from a classic pairs and anti-pairs database 361 when generating one or more recipe recommendations. The food and beverage pairing engine 363 may generate one or more recipe pairing recommendations using virtual cooking results stored within a VCR database. More information regarding the generation of recipe pairing recommendations is described later in reference to FIGS. 9A-9C.

The multi-meal planning engine 364 of FIG. 3F may generate one or more multi-meal recipe recommendations using virtual cooking results stored within a VCR database. More information regarding the generation of multi-meal recipe recommendations is described later in reference to FIGS. 9D-9E.

The recipe helper engine 367 of FIG. 3F may generate one or more recipe recommendations including recipes that are optimized to satisfy a particular flavor profile. A flavor profile may include one or more taste values, one or more aromatic values, one or more mouthfeel values, and/or one or more flavor metrics. More information regarding the generation of recipes optimized for a particular flavor profile is described later in reference to FIGS. 9F-9G.

The user preferences filter 365 of FIG. 3F may receive one or more recipes from one or more of the food and beverage pairing engine 363, multi-meal planning engine 364, and recipe helper engine 367. The user preferences filter 365 filters the one or more recipes according to user-defined recipe preferences. For example, all recipes with a particular ingredient or satisfying one or more recipe constraints may be filtered and outputted to the precluded results filter 366. The precluded results filter 366 may preclude certain recipes from being outputted from the food and beverage recommendation system 290. In one example, recipes that have been identified as being disliked by an end user (e.g., by the end user selecting a “dislike” button associated with a particular recipe) may be precluded as a recommended recipe. Recipes that take more than a particular time to prepare and cook or cost more than a particular recipe budget amount to prepare and cook may also be precluded.

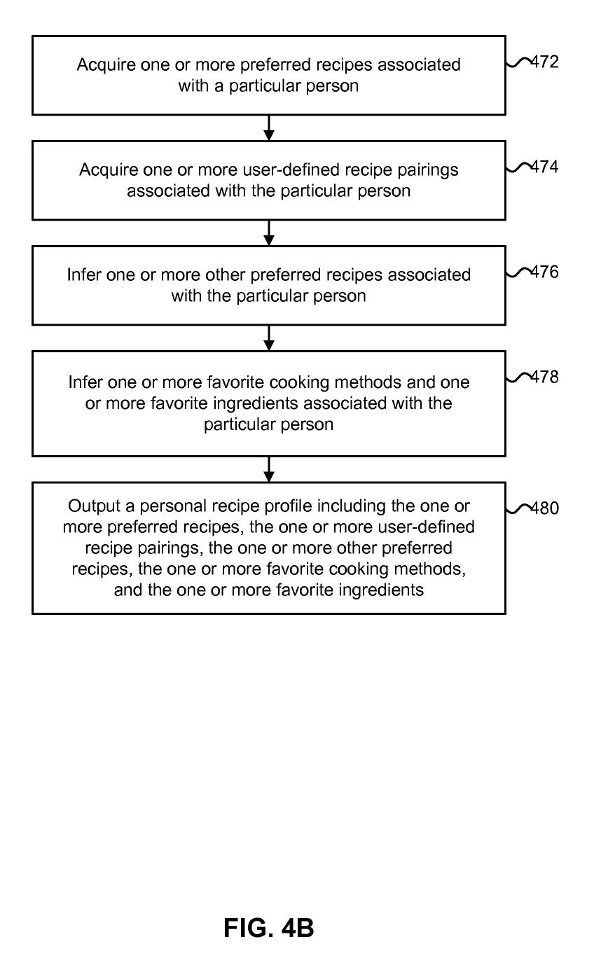

FIG. 4A is a flowchart describing one embodiment of a process for generating one or more recipe recommendations. In one embodiment, the process of FIG. 4A is performed by a computing device, such as virtual cooking server 150 in FIG. 1.

In step 402, a recipe is acquired. The recipe may include one or more ingredients and one or more cooking steps (e.g., baking a subset of the ingredients). The recipe may be acquired in a digital form (e.g., imported as a text file) or in an image form (e.g., a picture of the recipe) and subsequently converted into a digital form via optical character recognition (OCR) techniques. In some cases, natural language processing and/or machine translation techniques may be applied to the recipe in order to parse and identify the one or more ingredients and the one or more cooking steps. In step 403, a personal recipe profile is acquired. The personal recipe profile may include one or more user-defined recipe pairings and one or more recipe constraints. In one example, the one or more user-defined recipe pairings may include a particular recipe (e.g., a garlic chicken recipe) and a corresponding list of one or more other recipes that may be paired with the particular recipe (e.g., mashed potatoes or green beans). The one or more recipe constraints may include requirements such as a recommended recipe must have less than a maximum number of ingredients or must include a particular ingredient. One embodiment of a process for acquiring a personal recipe profile is described later in reference to FIG. 4B.

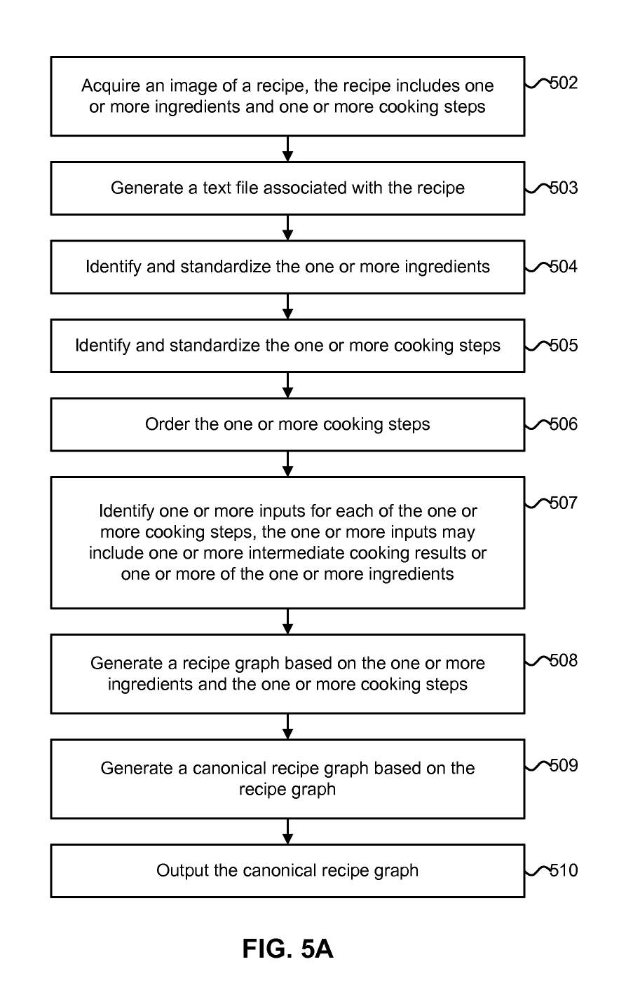

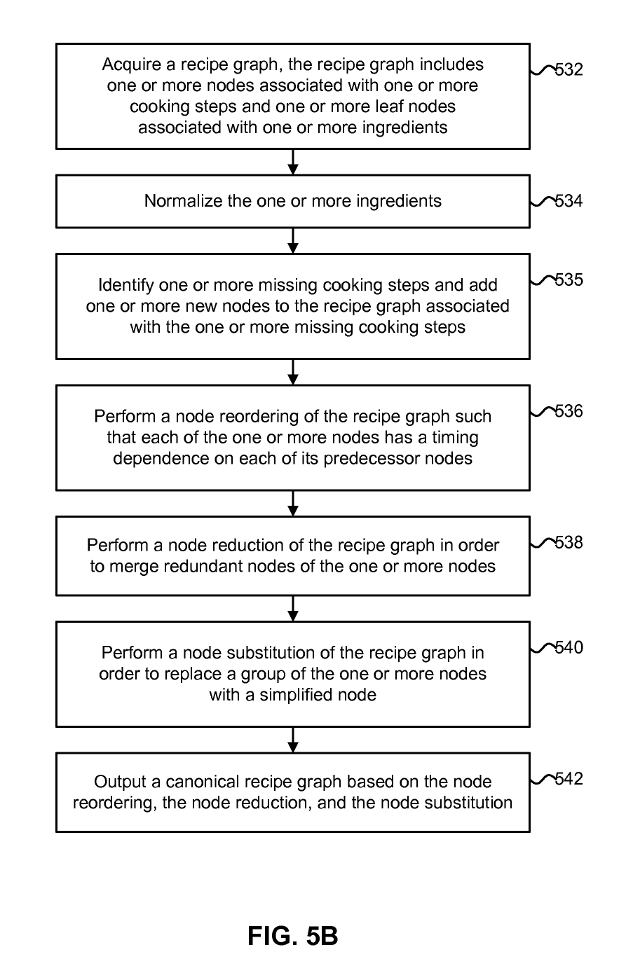

In step 404, a recipe graph based on the recipe is generated. The recipe graph may include a root node associated with the last cooking step to be performed, one or more leaf nodes associated with each of the input ingredients, and one or more other nodes associated with internal cooking results that are used in subsequent cooking steps. In one embodiment, the recipe graph may be represented as a directed acyclic graph (DAG). A predecessor node of a particular node may correspond with an ingredient or a cooking step that must be performed prior to the cooking step associated with the particular node. A successor node of a particular node may correspond with a cooking step that must be performed subsequent to the cooking step associated with the particular node. One embodiment of a process for generating a recipe graph based on a recipe is described later in reference to FIG. 5A.

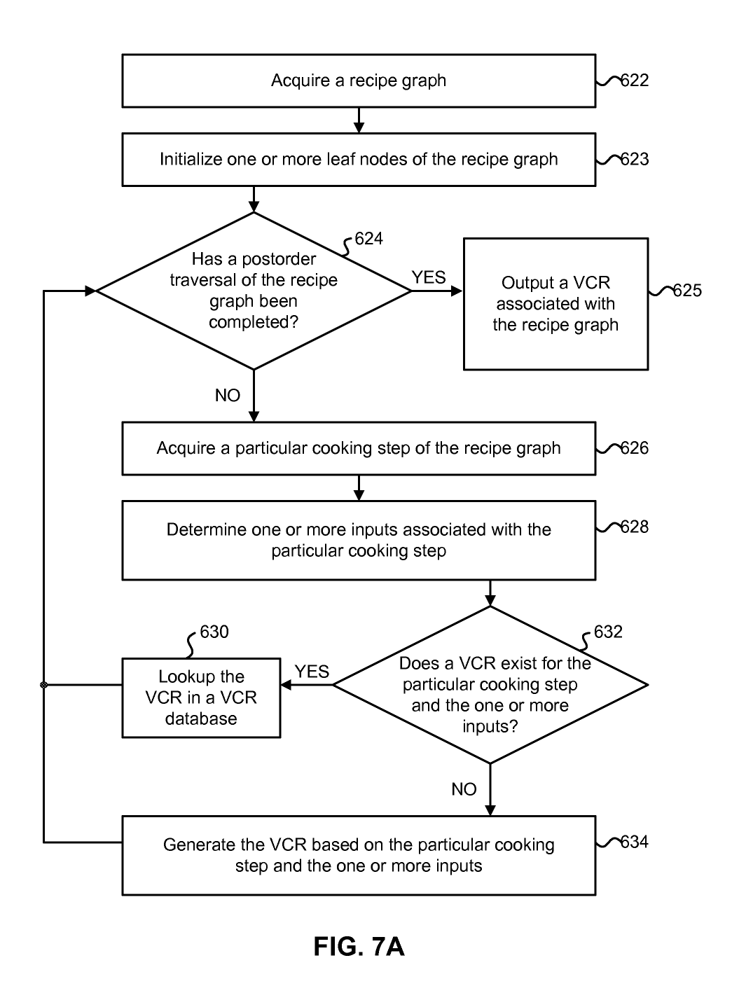

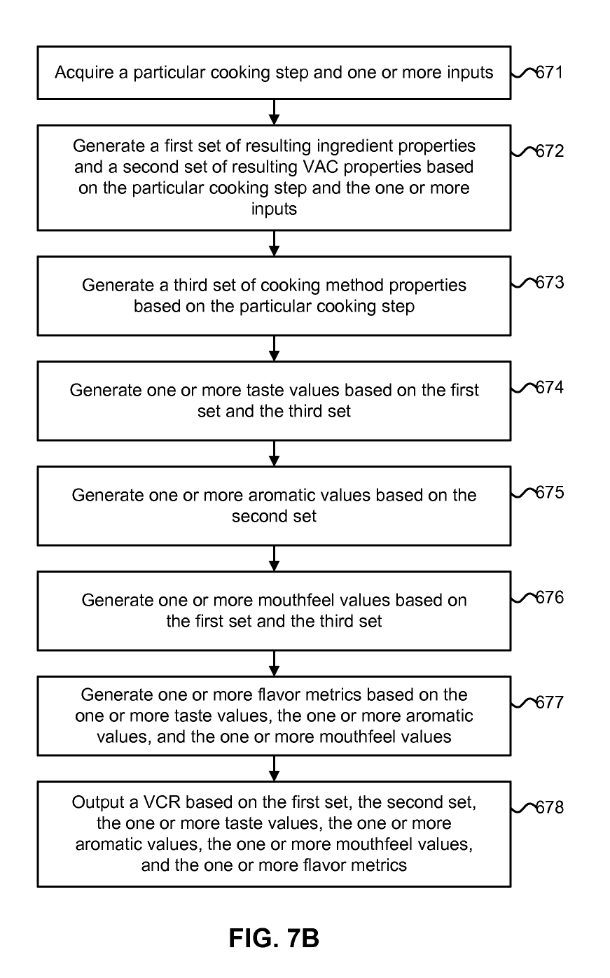

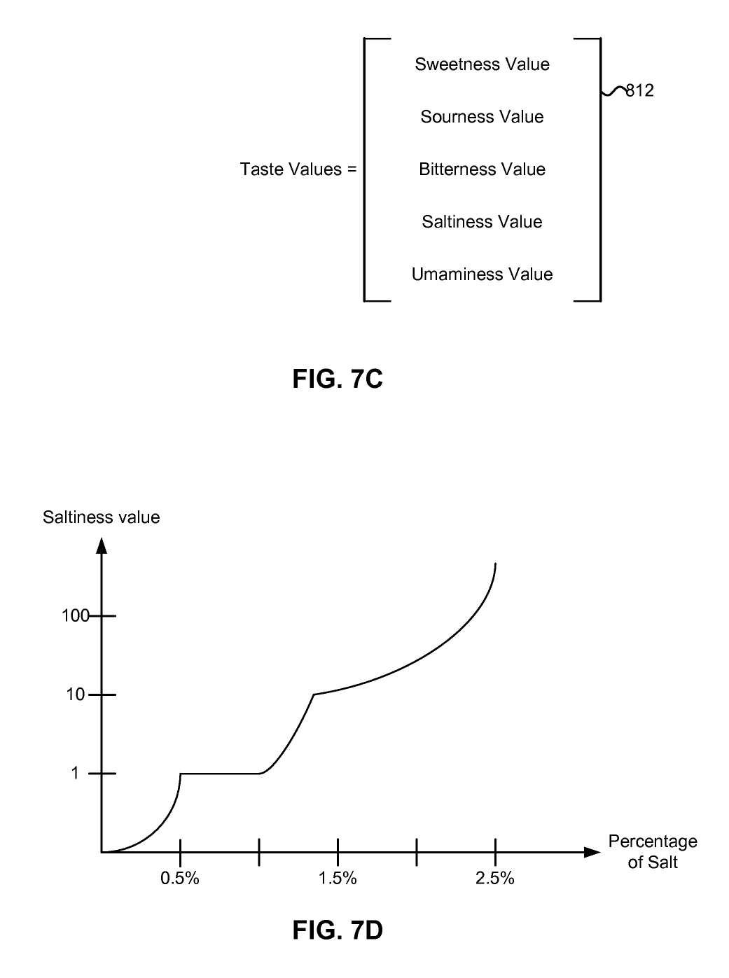

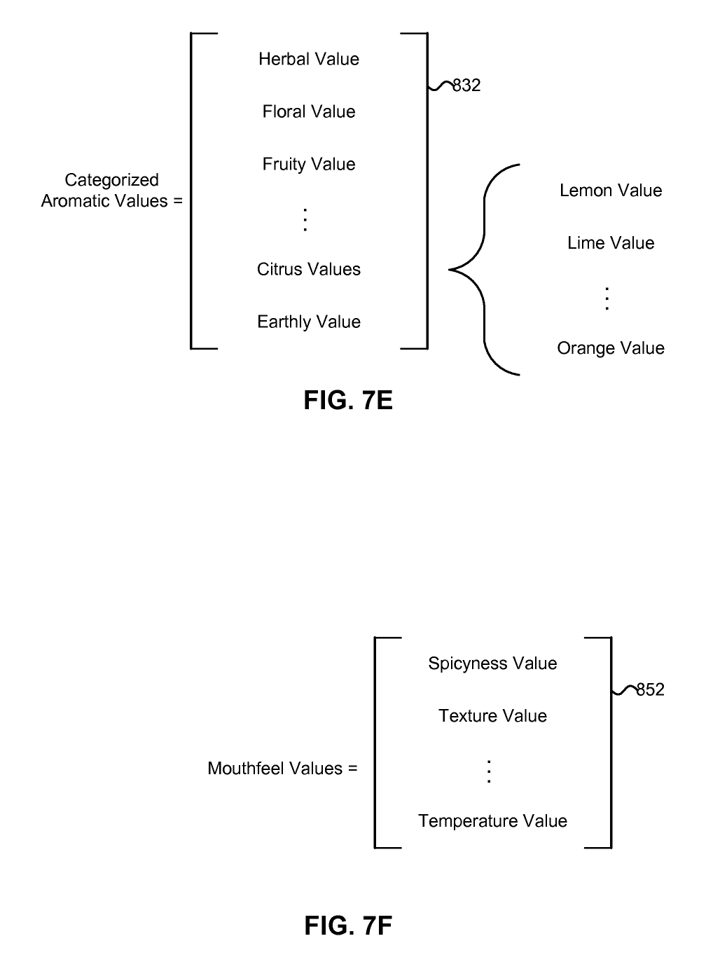

In step 406, a virtual cooking result (VCR) is generated based on the recipe graph generated in step 404. The VCR may include various quantitative representations of expected characteristics of the recipe including one or more estimated flavors associated with the recipe. In one example, the VCR may include an array of resulting ingredients, resulting volatile aromatic compounds, and resulting expected flavors associated with the recipe. One embodiment of a process for generating a virtual cooking result based on a recipe graph is described later in reference to FIG. 7A. In one embodiment, a recipe graph may comprise a single node (e.g., fresh strawberries) and a VCR may be generated based on the single node.

In some embodiments, the VCR may include one or more taste values including a sweetness value, a sourness value, a bitterness value, a saltiness value, and an umaminess value. The VCR may also include one or more aromatic values including a citrus value, a floral value, a fruity value, and an herbal value. The VCR may also include one or more mouthfeel values including a spiciness value and a temperature value. Furthermore, the VCR may include one or more flavor metrics including a total flavor intensity value associated with the recipe and one or more flavor intensity derivatives. In one example, a first flavor intensity derivative of the one or more flavor intensity derivatives may include a difference between the sweetness value and the saltiness value. In one embodiment, the total flavor intensity value may be calculated as the sum of the one or more taste values and the one or more aromatic values. In another embodiment, the total flavor intensity value may be calculated as a weighted combination of the one or more taste values and the one or more aromatic values.

In some embodiments, the virtual cooking result may be generated by calculating a first set of resulting ingredients, a second set of resulting volatile aromatic compounds, and a third set of cooking method properties associated with the root node of the recipe graph. In some embodiments, a postorder traversal of the recipe graph may be performed such that cooking steps associated with predecessor nodes of the root node are analyzed prior to analyzing the root node. Other graph traversals of the recipe graph in which predecessor nodes of a particular graph node are analyzed prior to analyzing the particular graph node may also be used. The one or more taste values may be derived from the first set of resulting ingredients and the one or more aromatic values may be derived from the second set of resulting volatile aromatic compounds. The one or more mouthfeel values may be derived from the third set of cooking method properties and the first set of resulting ingredients. The one or more flavor metrics may be derived from the one or more taste values and the one or more aromatic values.

In step 408 of FIG. 4A, the VCR generated in step 406 is indexed and stored as a VCR entry within a VCR database, such as VCR database 280 in FIG. 3A. The VCR entry may be indexed by a unique recipe identifier. In some cases, the VCR itself may be used as the unique recipe identifier. The VCR entry may also be linked to a digital representation of the recipe associated with the VCR.

In step 410, one or more recipe recommendations are generated based on the VCR generated in step 406. Various embodiments of processes for generating one or more recipe recommendations based on a VCR are described later in reference to FIGS. 9A-9G. In some embodiments, the one or more recipe recommendations may be generated based on the VCR and the personal recipe profile acquired in step 403. The one or more recipe recommendations may be generated by comparing the total flavor intensity value associated with a particular recipe with one or more different total flavor intensity values associated with different recipes. The one or more recipe recommendations may include recipe pairing recommendations, multi-meal recipe recommendations, and/or new recipes optimized to satisfy a particular flavor profile (e.g., recipes that satisfy one or more particular flavor values including taste values and aromatic values).

In some embodiments, the one or more recipe recommendations may be generated using machine learning techniques. The machine learning techniques may use a training set of recipe pairs which may include one or more user-defined recipe pairs. The machine learning techniques may assign confidence values to each of the one or more recipe recommendations based on a flavor distance between a recommended recipe and a recipe included within the one or more user-defined recipe pairs. In some cases, the machine learning techniques may use neural networks or support vector machines.

In some embodiments, generating the one or more recipe recommendations may include identifying one or more other virtual cooking results stored within a virtual cooking results database based on the VCR. The identifying one or more other virtual cooking results stored within a virtual cooking results database may include comparing the VCR with each of the virtual cooking results stored within the virtual cooking results database. The one or more other virtual cooking results may include a first virtual cooking result including one or more first taste values, one or more first aromatic values, and a first flavor intensity value. The identifying one or more other virtual cooking results stored within the virtual cooking results database may include comparing the one or more taste values with the one or more first taste values, comparing the one or more aromatic values with the one or more first aromatic values, and comparing the total flavor intensity value with the first flavor intensity value. Each of the one or more other virtual cooking results may be deemed to be similar in some way to the VCR (e.g., both the VCR and the first virtual cooking result may share the same volatile aromatic compounds).

In step 412, the one or more recipe recommendations are displayed. The one or more recipe recommendations may be displayed on a mobile device, such as mobile device 122 and FIG. 1. Each of the one or more recipe recommendations may be displayed as an ordered list of instructions associated with a corresponding recipe graph. The one or more recipe recommendations may be translated from a standardized representation (e.g., a graph representation) into a natural language form and displayed in various languages (e.g., English, French, or Japanese). In one embodiment, post-processing of the one or more recipe recommendations may be performed in order to provide additional information or guidance as to potential ingredient substitutions (e.g., to lower ingredient costs or to promote ingredients that are in season).

In some embodiments, post-processing of the recipe graphs associated with the one or more recipe recommendations may be performed in order to provide additional information or guidance as to which cooking steps should be performed at a particular time based on restrictions as to the number of cooking resources available at the particular time (e.g., the number of cooks or the number of ovens or mixers available for use at the particular time). In some cases, a time delay may be associated with each node in a recipe graph representing the estimated preparation and/or cooking time associated with the node. The minimum preparation and cooking time for the entire recipe graph may be determined by performing static timing analysis or identifying the critical path of the recipe graph and summing the delays along the critical path. In some cases, given time delays and resource constraints, a PERT analysis of the recipe graph may be performed in order to determine the overall preparation and cooking time for the recipe graph.

FIG. 4B is a flowchart describing one embodiment of a process for acquiring a personal recipe profile. The process described in FIG. 4B is one example of a process for implementing step 403 in FIG. 4A. In one embodiment, the process of FIG. 4B is performed by a computing device, such as virtual cooking server 150 in FIG. 1.

In step 472, one or more preferred recipes associated with a particular person are acquired. The one or more preferred recipes may be determined by the particular person by communicating a preference for the one or more preferred recipes (e.g., by selecting a “like” button associated with a preferred recipe). In one embodiment, one or more preferred recipes may be determined by the particular person by communicating a preference for one or more particular ingredients (e.g., lobster) and/or one or more particular cooking methods (e.g., grilling) occurring within each of the one or more preferred recipes. In step 474, one or more user-defined recipe pairings associated with the particular person are acquired. The one or more user-defined recipe pairings may include a list of recipes and pointers for each recipe in the list of recipes to one or more paired recipes.

In step 476, one or more other preferred recipes associated with the particular person are inferred. A preferred recipe of the one or more other preferred recipes may be inferred by identifying a particular recipe in which the amount of time the particular person has spent accessing and/or searching for the particular recipe in an online recipe database is greater than a threshold. A preferred recipe may also be inferred by identifying positive comments or ratings associated with the particular recipe given by the particular person. In some embodiments, the preferred recipe may be inferred by identifying the inclusion of a particular recipe within an electronic cookbook associated with the particular person and/or identifying the exportation of particular ingredients associated with the particular recipe included within the electronic cookbook into a digital shopping list (e.g., a shopping list that may be used by an online grocery delivery service).

In step 478, one or more favorite cooking methods and one or more favorite ingredients associated with the particular person are inferred. The one or more favorite cooking methods and one or more favorite ingredients may be inferred by identifying commonly used recipe search terms used by the particular person when accessing an online recipe database. In step 480, a personal recipe profile associated with the particular person is outputted. The personal recipe profile may include the one or more preferred recipes acquired in step 472, the one or more user-defined recipe pairings acquired in step 474, the one or more other preferred recipes inferred in step 476, the one or more favorite cooking methods inferred in step 478, and the one or more favorite ingredients inferred in step 478. The personal recipe profile may be used by a food and beverage recommendation system, such as food and beverage recommendation system 290 in FIG. 3F, in order to generate one or more recipe recommendations for the particular person.

FIG. 5A is a flowchart describing one embodiment of a process for generating a recipe graph based on a recipe. The process described in FIG. 5A is one example of a process for implementing step 404 in FIG. 4A. In one embodiment, the process of FIG. 5A is performed by a computing device, such as virtual cooking server 150 in FIG. 1.

In step 502, an image of a recipe is acquired. The recipe may include one or more ingredients and one or more cooking steps. In one example, the image of the recipe is acquired using an image capture device associated with a mobile device, such as mobile device 122 in FIG. 1. In step 503, a text file associated with the recipe is generated. The text file may be generated by applying optical character recognition (OCR) techniques to the image of the recipe.

In step 504, the one or more ingredients are identified and standardized. The one or more ingredients may be identified by applying pattern matching or character matching techniques to the text file. The one or more ingredients may be standardized by comparing the one or more ingredients with a predefined set of recognized ingredients (e.g., a predefined table of known ingredients). The predefined set of recognized ingredients may account for different spellings and synonyms associated with the one or more ingredients. For example, the terms onion and cebolla may map to the same standardized ingredient. If a particular ingredient of the one or more ingredients is not recognized as existing within the predefined set of recognized ingredients, then additional information regarding the particular ingredient may be requested from an external source.

The one or more ingredients may also be standardized by mapping one or more amounts associated with the one or more ingredients into a base unit of mass such as grams or pounds. Ingredient amounts specified as volume unit measurements may be converted into a corresponding mass using a lookup table of volume to mass conversions or by acquiring density information associated with a particular ingredient being converted. In one embodiment, ingredient volume to ingredient mass mappings may be performed using a physical properties of ingredients database, such as physical properties of ingredients database 322 of FIG. 3C. The physical properties of ingredients database may also be used to convert ingredient amounts specified as a variable natural quantity, such as a whole onion or a large egg, into a corresponding mass by using a lookup table of standardized natural quantities. In one embodiment, ingredient amounts may be binned or quantized into a discrete number of quantities (e.g., using only an integer number of grams).

In step 505, the one or more cooking steps are identified and standardized. The one or more cooking steps may be identified by applying pattern matching or character matching techniques to the text file. The one or more cooking steps may be standardized by comparing the one or more cooking steps with a predefined set of recognized cooking steps (e.g., a predefined table of known cooking steps). The predefined set of recognized cooking steps may account for different spellings and synonyms associated with the one or more cooking steps. Each recognized cooking step may be labeled with a concise name for the cooking step, such as bake, chop, sauté, mix, or separate.

In step 506, the one or more cooking steps are ordered. A particular cooking step of the one or more cooking steps may be ordered based on timing dependencies with other cooking steps of the one or more cooking steps. For example, the particular cooking step may be designated a predecessor step of a subsequent cooking step if results of the particular cooking step are required by the subsequent cooking step. The particular cooking step may be designated a successor step of a preceding cooking step if results of the preceding cooking step are required by the particular cooking step.

In step 507, one or more inputs for each of the one or more cooking steps are identified. The one or more inputs may include one or more intermediate cooking results or one or more of the one or more ingredients identified and standardized in step 504. One or more inputs identified for a particular node may correspond with input edges to the particular node. In step 508, a recipe graph based on the one or more ingredients and the one or more cooking steps is generated. A root node associated with the recipe graph is associated with the last cooking step of the recipe. Leaf nodes of the recipe graph are associated with the one or more ingredients. Other nodes associated with the recipe graph may represent intermediate cooking steps which provide intermediate cooking results to subsequent cooking steps.

In step 509, a canonical recipe graph is generated based on the recipe graph generated in step 508. One embodiment of a process for generating a canonical recipe graph is described later in reference to FIG. 5B. In step 510, the canonical recipe graph is outputted.

FIG. 5B is a flowchart describing one embodiment of a process for generating a canonical recipe graph. The process described in FIG. 5B is one example of a process for implementing step 509 in FIG. 5A. In one embodiment, the process of FIG. 5B is performed by a computing device, such as virtual cooking server 150 in FIG. 1.

In step 532, a recipe graph is acquired. The recipe graph may include one or more nodes associated with one or more cooking steps and one or more leaf nodes associated with one or more ingredients. In step 534, the one or more ingredients may be normalized. In one embodiment, every ingredient associated with a recipe is normalized to the water content within the recipe (i.e., each ingredient is ratioed to the amount of water in the recipe).

In step 535, one or more missing cooking steps are identified and, in response, one or more new nodes are added to the recipe graph associated with the one or more missing cooking steps. In one example, an input ingredient of 2 cups of mild cheddar may require a shredding cooking step in order to provide the 2 cups of mild cheddar. If the shredding cooking step is missing from the recipe, it may be deemed a missing cooking step.

In step 536, a node reordering of the recipe graph is performed such that each of the one or more nodes has a timing dependence on each of its predecessor nodes. The node reordering step may minimize the height of the recipe graph by removing unnecessary timing dependencies. For example, a recipe graph may include a first node associated with chopping a first ingredient, a second node associated with chopping a second ingredient, and a third node associated with a baking step where the first ingredient and the second ingredient are combined and baked. The first node may be a predecessor to the second node and the second node may be a predecessor to the third node. However, in this case, the second node does not have a timing dependence on the first node as both the chopping of the first ingredient and the chopping of the second ingredient may be performed in parallel. Therefore, the node reordering step would adjust the graph such that both the first node and the second node are direct predecessors to the third node.

In step 538, a node reduction of the recipe graph is performed in order to merge redundant nodes of the one or more nodes. A successor node and a predecessor node may be deemed redundant if they share an edge of the recipe graph and if merging the cooking steps will not alter the virtual cooking result of the successor node. In step 540, a node substitution of the recipe graph is performed in order to replace a group of the one or more nodes with a simplified node. In one example, the simplified node may correspond with a commonly performed action such as activating yeast. In another example, the simplified node may correspond with a cooking template associated with a predetermined cooking result such as boiling pasta in order to provide cooked macaroni. In step 542, a canonical recipe graph based on the node reordering of step 536, the node reduction of step 538, and the node substitution of step 540 is outputted.

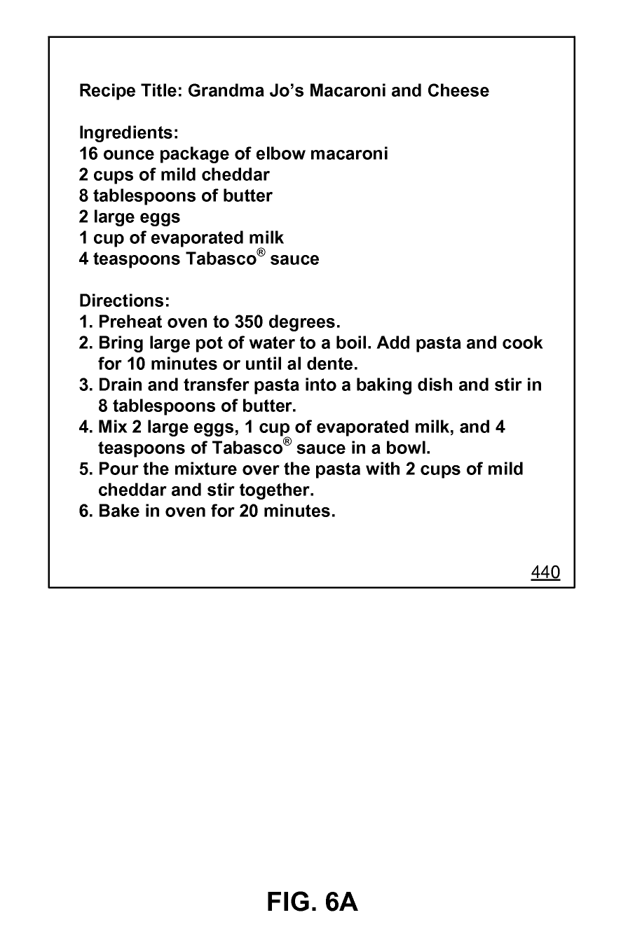

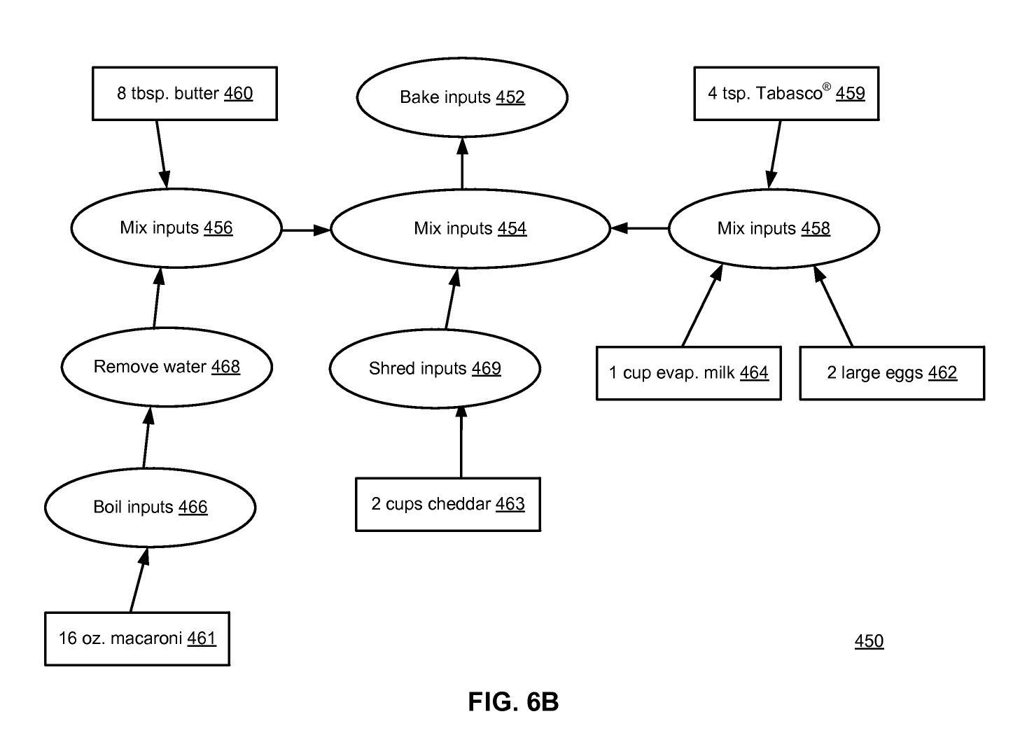

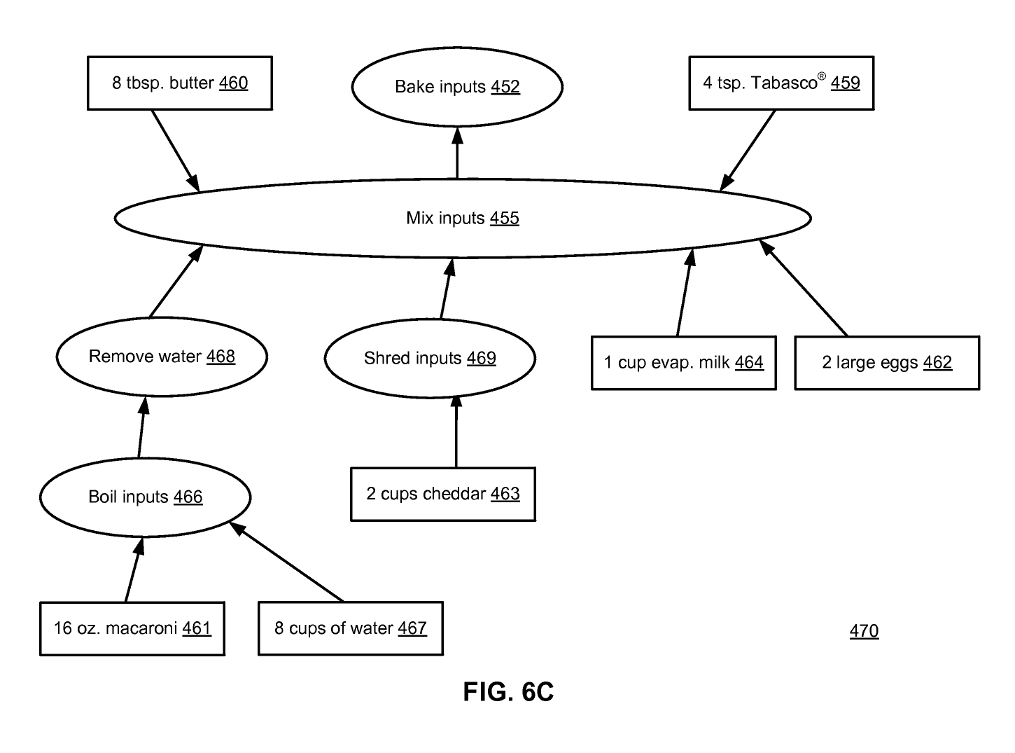

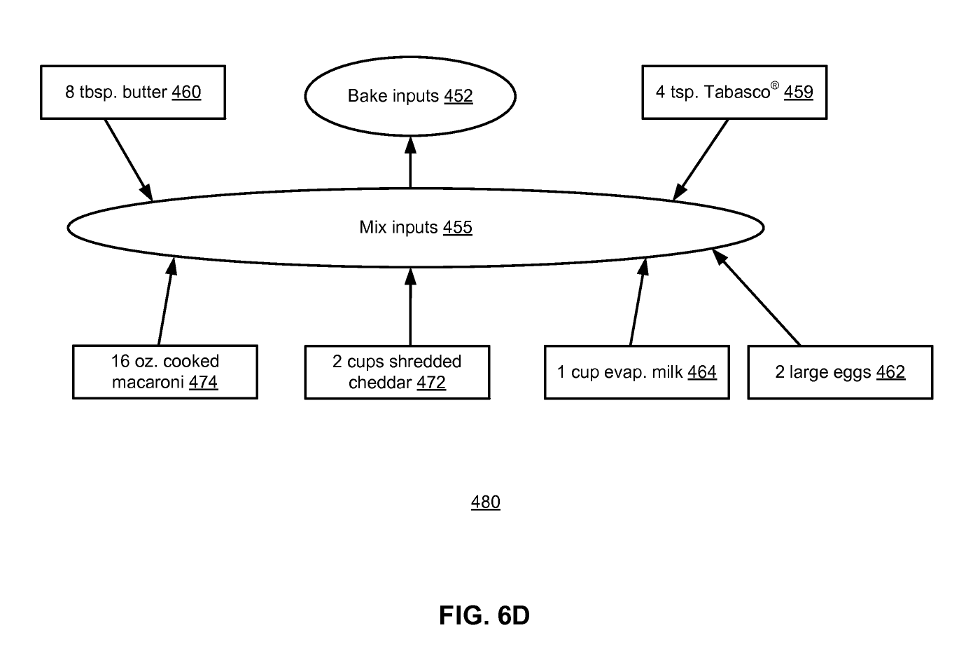

FIG. 6A depicts one embodiment of a recipe 440. The recipe 440 includes one or more ingredients and one or more directions associated with one or more cooking steps. The recipe 440 also includes a recipe title “Grandma Jo's Macaroni and Cheese,” which may comprise metadata and be used by a search engine in order to retrieve the recipe.

FIG. 6B depicts one embodiment of a recipe graph 450 associated with the recipe 440 of FIG. 6A. As depicted, the one or more ingredients of 16 ounces of elbow macaroni, 2 cups of mild cheddar, 8 tablespoons of butter, two large eggs, 1 cup of the evaporated milk, and 4 teaspoons of Tabasco® sauce are represented as leaf nodes 459-464 of the recipe graph 450. The last cooking step of bake inputs 452 is associated with the root node of recipe graph 450. The root node has a predecessor node associated with mix inputs 454. The node associated with mix inputs 454 has predecessor nodes associated with mix inputs 456, mix inputs 458, and shred inputs 469. The node associated with mix inputs 456 has a predecessor node associated with remove water 468. The node associated with remove water 468 has a predecessor node associated with boil inputs 466. Leaf nodes 459, 462, and 464 are predecessor nodes of the node associated with mix inputs 458. Leaf node 463 is a predecessor node of the node associated with shred inputs 469. Leaf node 461 is a predecessor node of the node associated with boil inputs 466. Leaf node 460 is a predecessor node of the node associated with mix inputs 456.

FIG. 6C depicts one embodiment of a recipe graph 470 after node reduction and the addition of missing steps or ingredients have been performed on recipe graph 450 of FIG. 6B. As depicted, the three nodes associated with mix inputs 456, mix inputs 454, and mix inputs 458 have been merged into a simplified node associated with mix inputs 455. A new leaf node associated with 8 cups of water 467 has been added as an input to the cooking step of boil inputs 466. The amount of water added may be a default value or based on information provided in the recipe such as “a large pot of water.”

In some embodiments, although the three nodes associated with mix inputs 456, mix inputs 454, and mix inputs 458 all share a common cooking step (i.e., mixing the inputs), only the nodes associated with mix inputs 454 and mix inputs 458 may be merged into a simplified node, thereby preserving the node associated with mix inputs 456. In this case, all three nodes are not merged together in order to preserve, for example, melting the butter with the warm macaroni at the node associated with mix inputs 456 and making sure that the eggs are properly diluted before spreading the mixture associated with mix inputs 458 with the macaroni.

FIG. 6D depicts one embodiment of a recipe graph 480 after node substitution has been performed on recipe graph 470 of FIG. 6C. As depicted, a new leaf node associated with 16 ounces of cooked macaroni 474 has been substituted for nodes 461 and 466-468 of recipe graph 470 of FIG. 6C. A new leaf node associated with 2 cups of shredded cheddar 472 has been substituted for node 469 and node 463 of recipe graph 470 of FIG. 6C. Recipe graph 480 may comprise a canonical recipe graph.

In some embodiments, node substitution may be performed by identifying a group of one or more nodes within a recipe graph and replacing the group of one or more nodes with a simplified node. The simplified node may embody a cooking template associated with a predetermined cooking result. In one example, recipe graph nodes associated with creating a roux (e.g., mixing wheat flour with butter or vegetable oil as a fat base) are substituted for a simplified node corresponding with the roux. Other cooking templates associated with commonly performed cooking steps and/or commonly used ingredients may also be applied during node substitution.

FIG. 7A is a flowchart describing one embodiment of a process for generating a virtual cooking result based on a recipe graph. The process described in FIG. 7A is one example of a process for implementing step 406 in FIG. 4A. In one embodiment, the process of FIG. 7A is performed by a computing device, such as virtual cooking server 150 in FIG. 1.

In step 622, a recipe graph is acquired. In step 623, one or more leaf nodes of the recipe graph are initialized. In one embodiment, the one or more leaf nodes may be initialized by generating a virtual cooking result for each of the leaf nodes. In step 624, it is determined whether a postorder traversal of the recipe graph has been completed. If it is determined that a postorder traversal of the recipe graph has been completed, then step 625 is performed. Otherwise, if it is determined that a postorder traversal of the recipe graph has not been completed, then step 626 is performed. In step 625, a VCR associated with the recipe graph is outputted. For example, a VCR associated with the root node of the recipe graph may be outputted.

In step 626, a particular cooking step of the recipe graph is acquired. In step 628, one or more inputs associated with the particular cooking step are determined. The one or more inputs may include input ingredients and/or intermediate cooking results required by the particular cooking step. In one embodiment, the one or more inputs may include virtual cooking results associated with one or more intermediate cooking results or virtual cooking results associated with one or more of the one or more leaf nodes.

In step 632, it is determined whether a VCR already exists for the particular cooking step and the one or more inputs determined in step 628. If it is determined that a VCR already exists, then step 630 is performed. Otherwise, if it is determined that a VCR does not already exist, then step 634 is performed. A VCR may be deemed to already exist if there is a corresponding entry within a VCR database, such as VCR database 280 in FIG. 3A, with a root cooking step matching the particular cooking step and one or more root inputs matching the one or more inputs determined in step 628. In some cases, the one or more root inputs match the one or more inputs if there is an equivalence with respect to both the number and type of input ingredients as well as the amounts of each input ingredient.

In step 630, the matching VCR is looked up in a VCR database, such as VCR database 280 and FIG. 3A. The matching VCR may be associated with the particular cooking step and used as an input to successor nodes in the recipe graph. After step 630 is performed, step 624 is performed. In step 634, a VCR based on the particular cooking step and the one or more inputs determined in step 628 is generated. One embodiment of a process for generating a VCR based on a particular cooking step and one or more inputs is described later in reference to FIG. 7B. After step 634 is performed, step 624 is performed.

FIG. 7B is a flowchart describing one embodiment of a process for generating a VCR based on a particular cooking step and one or more inputs. The process described in FIG. 7B is one example of a process for implementing step 634 in FIG. 7A. In one embodiment, the process of FIG. 7B is performed by a computing device, such as virtual cooking server 150 in FIG. 1.

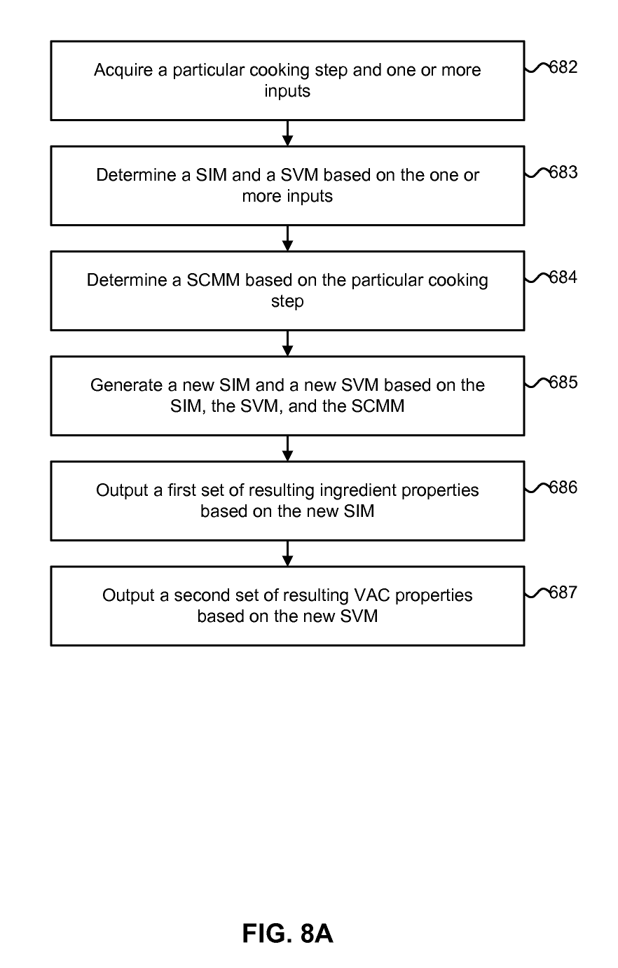

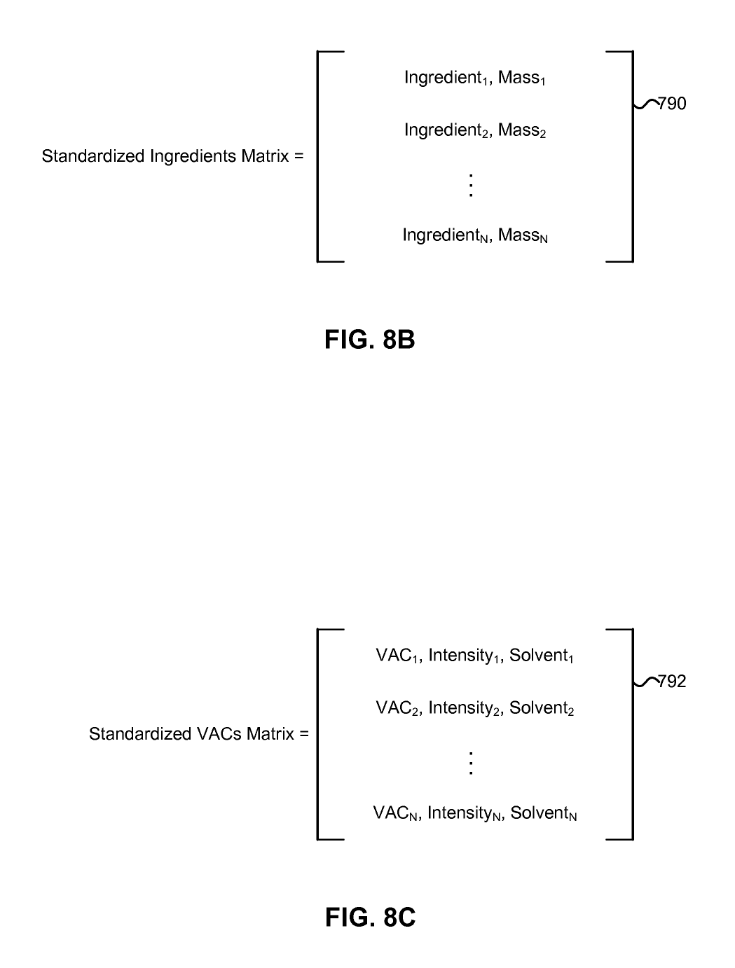

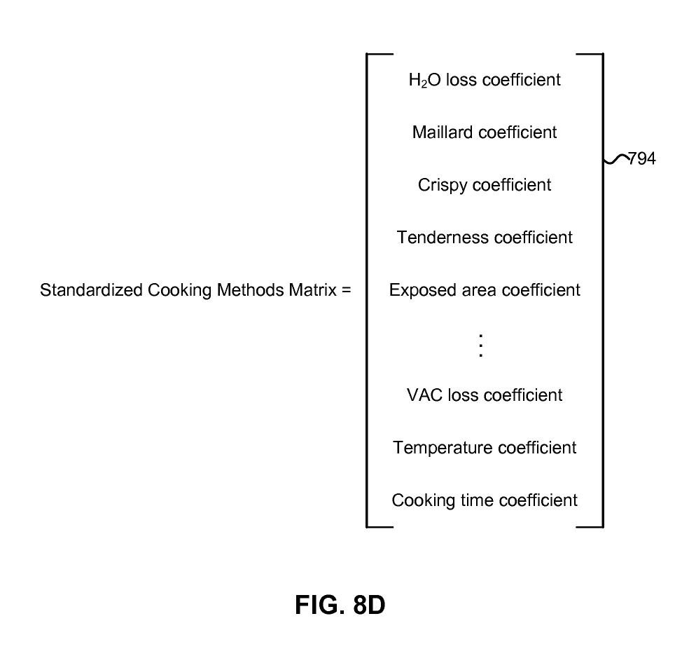

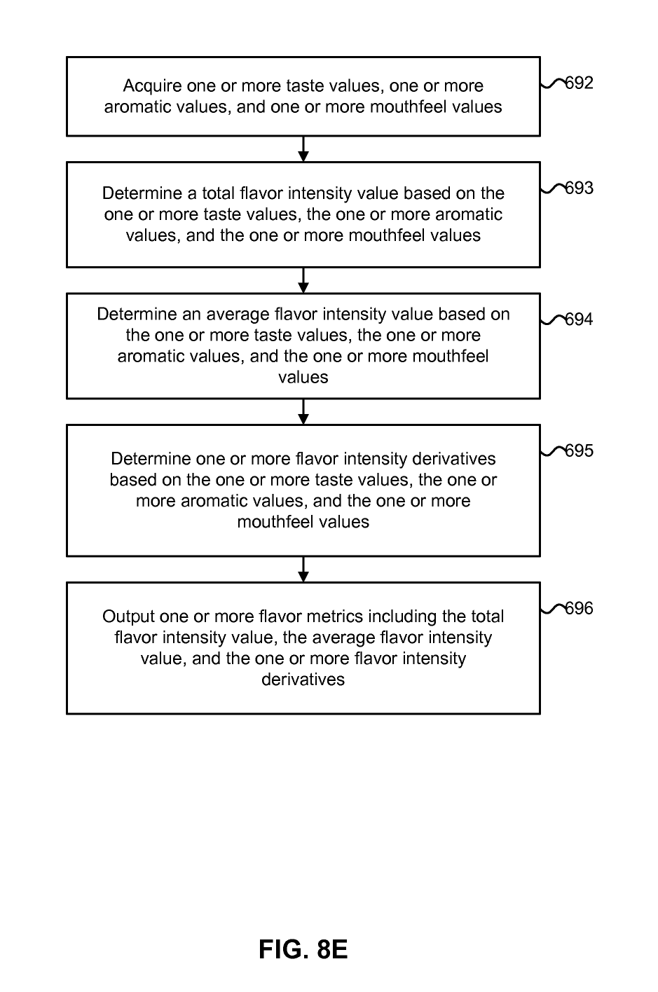

In step 671, a particular cooking step and one or more inputs are acquired. In step 672, a first set of resulting ingredient properties and a second set of resulting VAC properties are generated based on the particular cooking step and the one or more inputs acquired in step 671. One embodiment of a process for generating a first set of resulting ingredient properties and a second set of resulting VAC properties is described later in reference to FIG. 8A.

In step 673 of FIG. 7B, a third set of cooking method properties is generated based on the particular cooking step. The third set of cooking method properties may include temperature information associated with the particular cooking step. The temperature information may be used to scale one or more flavor values generated in steps 674-676. In step 674, one or more taste values based on the first set and the third set are generated.

FIG. 7C depicts one embodiment of a taste values matrix 812 including a sweetness value, a sourness value, a bitterness value, a saltiness value, and an umaminess value. In one embodiment, the sweetness value is based on a sweetness ratio between a sum of the masses of various sugars present within the one or more inputs and a total ingredient mass associated with all of the input ingredients. In some cases, the exposed surface area associated with a subset of the one or more input ingredients associated with sugars (e.g., white sugar, corn syrup, honey, or various fruits) may be used to scale the sweetness value. The sweetness value may be a nonlinear function of the sweetness ratio.

In one embodiment, the sourness value is based on an identification of common ingredients that have a pH (i.e., a measure of the acidity or basicity of a solution) outside of a neutral range. For example, the common ingredients may include common alkaline ingredients such as baking soda and common acidic ingredients such as lemon. The sourness value may be based on a first basic ratio between a sum of the masses of various alkaline ingredients within the one or more inputs and a total ingredient mass associated with all of the input ingredients and a second acidic ratio between a sum of the masses of various acidic ingredients within the one or more inputs and a total ingredient mass associated with all of the input ingredients. A sourness difference may be calculated as a difference between the first basic ratio and the second acidic ratio. A sourness difference of zero implies a neutral recipe. The sourness value may be a nonlinear function of the sourness difference.

In one embodiment, the bitterness value may be determined by identifying common ingredients associated with a bitter taste and calculating a bitterness ratio between a sum of the masses of various bitter ingredients within the one or more inputs and a total ingredient mass associated with all of the input ingredients. The bitterness value may be a nonlinear function of the bitterness ratio.

In one embodiment, the saltiness value may be determined by identifying common ingredients associated with various salts and calculating a saltiness ratio between a sum of the masses of various salty ingredients (e.g., sodium chloride) within the one or more inputs and a total ingredient mass associated with all of the input ingredients. The saltiness value may be a nonlinear function of the saltiness ratio. FIG. 7D depicts one embodiment of a function for determining a saltiness value given input ingredients. The percentage of salt may comprise a ratio between a sum of the masses of various salts within a recipe (e.g., sodium chloride, potassium chloride, or magnesium chloride) to a total ingredient mass associated with all of the input ingredients. As the natural salinity of human saliva is on the order of 0.5%-1.0% by mass, foods that have a salinity of less than 0.5% may be deemed bland, while foods that have a salinity of more than 1.0% may be deemed salty.

In one embodiment, the umaminess value may be determined by identifying common ingredients and cooking steps associated with umami sensations, which are typically produced by a Maillard reaction involving amino acids, certain sugars, and heat. Maillard reactions may also be accelerated in an alkaline environment. Thus, both the input ingredients and the cooking step performed are important contributors to the umaminess value. The umaminess value may be determined using machine learning techniques. The machine learning techniques may use training sets comprising input ingredients and cooking steps, and their corresponding umaminess value.

In step 675 of FIG. 7B, one or more aromatic values based on the second set are generated. FIG. 7E depicts one embodiment of a categorized aromatic values matrix 832. The categorized aromatic values matrix 832 includes an herbal value, a floral value, a fruity value, citrus values, and an earthy value. The citrus values may include a lemon value, a lime value, and an orange value. In one embodiment, the one or more aromatic values may be determined using a set of VAC lookup functions associated with various aromatic value categories. In one embodiment, each VAC lookup function may be associated with a particular aromatic category and normalized for a standard perception threshold. For example, the floral value may be determined by looking up the VACs associated with floral aromas and determining if any matching VACs associated with floral aromas provides a sufficient concentration threshold. The floral value may be a nonlinear function of a sum of matching VAC concentrations associated with floral aromas.

In step 676 of FIG. 7B, one or more mouthfeel values based on the first set and the third set are generated. FIG. 7F depicts one embodiment of a mouthfeel values matrix 852. The mouthfeel values matrix 852 includes a spiciness value, a texture value, and a temperature value. The spiciness value may comprise a degree of physical irritation of the mouth. The texture value may comprise a degree of smoothness or a degree of crispness. The temperature value may be based on a cooking temperature associated with the particular cooking step.

In step 677 of FIG. 7B, one or more flavor metrics are generated based on the one or more taste values generated in step 674, the one or more aromatic values generated in step 675, and the one or more mouthfeel values generated in step 676. In some embodiments, the one or more flavor metrics may be generated using machine learning techniques. The machine learning techniques may use a training set of various recipes and corresponding flavor metrics. In one example, the training set of various recipes may comprise recipes for a variety of dishes and the corresponding flavor metrics may include a perceived total flavor intensity value for each of the variety of dishes as perceived by a particular person or based on a standardized sensory evaluation sampling methodology. Each of the perceived total flavor intensity values associated with each dish may be given a numerical score on a scale of 1 to 100. In some cases, a virtual cooking result may be generated for each recipe in the training set. One embodiment of a process for generating one or more flavor metrics is described later in reference to FIG. 8E. In step 678, a VCR is outputted based on the first set, the second set, the one or more taste values, the one or more aromatic values, the one or more mouthfeel values, and the one or more flavor metrics.

FIG. 8A is a flowchart describing one embodiment of a process for generating a first set of resulting ingredient properties and a second set of resulting VAC properties. The process described in FIG. 8A is one example of a process for implementing step 672 in FIG. 7B. In one embodiment, the process of FIG. 8A is performed by a computing device, such as virtual cooking server 150 in FIG. 1.

In step 682, a particular cooking step and one or more inputs are acquired. In step 683, a standardized ingredient matrix (SIM) and a standardized VAC matrix (SVM) are determined based on the one or more inputs. In step 684, a standardized cooking methods matrix (SCMM) is determined based on the particular cooking step.

FIG. 8B depicts one embodiment of a SIM 790. The SIM 790 includes one or more ingredient listings. Each of the ingredient listings may be associated with an ingredient identifier (e.g., Ingredient₁) and a mass associated with the ingredient listing. The ingredient identifier may correspond with a standardized ingredient (e.g., each ingredient may be one of a predefined set of recognized ingredients). In one example, the ingredient identifier may be “onion” and correspond with onions, scallions, and cebolla. The mass may be represented in grams. Each of the ingredient listings may also be associated with an optional exposed area function associated with a solid food at room temperature. A melting temperature associated with each ingredient may be used to modify the exposed area function depending on the cooking temperature associated with the particular cooking step. In one embodiment, a reduced SIM may be generated wherein similar ingredients are grouped together. For example, ingredient listings for steak, beef, and lamb chops may be combined and mapped into a common red meat identifier.

FIG. 8C depicts one embodiment of a SVM 792. The SVM 792 includes one or more VAC listings. Each of the VAC listings may be associated with a VAC identifier (e.g., VAC₁), a VAC intensity function, and an identification of the solvent in which the particular VAC associated with the VAC identifier exists. The particular VAC may comprise a key odorant. The solvent may include a liquid such as water or alcohol, or a solid such as fat. Each solvent may be associated with a volatilization rate. The VAC intensity function may be a function of the cooking temperature and be based on a particular concentration threshold associated with the particular VAC (i.e., the particular VAC must be present in a sufficiently high concentration in order to be perceived).

FIG. 8D depicts one embodiment of a SCMM 794. The SCMM 794 includes various cooking methods coefficients such as a water loss coefficient, a Maillard reaction coefficient, a crispy coefficient, a tenderness coefficient, an exposed area coefficient, a VAC loss coefficient, a cooking temperature coefficient, and a cooking time coefficient. In one example, the exposed area coefficient may be determined such that an exposed area metric associated with a particular ingredient is modified due to a slicing or chopping cooking step. In another example, the water loss coefficient may be determined such that water loss due to evaporation based on the duration and temperature of a sautéing or frying cooking step may be estimated.

In step 685 of FIG. 8A, a new SIM and a new SVM are generated based on the SIM and SVM determined in step 683 and the SCMM determined in step 684. In some embodiments, the new SIM and new SVM may be generated based on estimations of simulated chemical reactions stored in a cooking chemistry database. The chemical reactions may include thermally activated processes. The cooking chemistry database may provide resulting ingredient mappings for various combinations of the ingredients listed within one or more SIMs based on predefined cooking method coefficients. For example, the resulting ingredients caused by a Maillard reaction may be estimated based on the ingredients within SIM 790 and the cooking method coefficients within SCMM 794 including coefficients associated with the cooking time, cooking temperature, and the exposed surface areas of particular ingredients. Other chemical reactions such as carbonization and carmelization reactions may also be estimated. In some embodiments, the new SIM and new SVM may be generated using machine learning techniques. The machine learning techniques may use training sets comprising input ingredients, VACs, and SCM coefficients, and their corresponding resulting ingredients and VACs in order to generate the new SIM and new SVM.

In step 686, a first set of resulting ingredient properties is outputted based on the new SIM generated in step 685. In step 687, a second set of resulting VAC properties is outputted based on the new SVM generated in step 685.

FIG. 8E is a flowchart describing one embodiment of a process for generating one or more flavor metrics. The process described in FIG. 8E is one example of a process for implementing step 677 in FIG. 7B. In one embodiment, the process of FIG. 8E is performed by a computing device, such as virtual cooking server 150 in FIG. 1.

In step 692, one or more taste values, one or more aromatic values, and one or more mouthfeel values are acquired. In step 693, a total flavor intensity value is determined based on the one or more taste values, the one or more aromatic values, and the one or more mouthfeel values. In one embodiment, the total flavor intensity value may be calculated by summing the one or more taste values and the one or more aromatic values. In another embodiment, the total flavor intensity value may be calculated as a weighted sum of the one or more taste values and the one or more aromatic values. The total flavor intensity value may also be calculated as a weighted combination of the one or more taste values, the one or more aromatic values, and the one or more mouthfeel values.

In step 694, an average flavor intensity value is determined based on the one or more taste values, the one or more aromatic values, and the one or more mouthfeel values. In one embodiment, the average flavor intensity value is calculated as the average value of the one or more taste values.

In step 695, one or more flavor intensity derivatives are determined based on the one or more taste values, the one or more aromatic values, and the one or more mouthfeel values. In one example, a flavor derivative value associated with the difference between the saltiness and the sweetness of a particular recipe may be calculated by determining a difference between a saltiness value and a sweetness value. In another example, a flavor derivative value may be calculated by determining a difference between a saltiness value and the sum of all other taste values. Flavor derivative values may also be calculated for the one or more aromatic values or between the one or more taste values and the one or more aromatic values. In one example, a flavor derivative value may be calculated by determining a difference between a fruity value and a citrus value. In another example, a flavor derivative may be calculated by determining a difference between a sweetness value and a fruity value.

In step 696, one or more flavor metrics are outputted. The one or more flavor metrics may include the total flavor intensity value determined in step 693, the average flavor intensity value determined in step 694, and the one or more flavor intensity derivatives determined in step 695.

FIGS. 9A-9G describe various embodiments for generating one or more recipe recommendations based on virtual cooking results. FIG. 9A is a flowchart describing one embodiment of a process for generating recipe pairings. The process described in FIG. 9A is one example of a process for implementing step 410 in FIG. 4A. In one embodiment, the process of FIG. 9A is performed by a computing device, such as virtual cooking server 150 in FIG. 1.

In step 902, a recipe is acquired. The recipe may be associated with one or more input ingredients and one or more cooking steps. In step 904, a VCR based on the recipe is generated. In one embodiment, the VCR may be generated by creating a recipe graph associated with the recipe, traversing the recipe graph, identifying one or more inputs associated with each of the one or more cooking steps of the recipe graph (e.g., identifying input ingredients and/or intermediate cooking results required by each of the one or more cooking steps), and generating the VCR based on the one or more cooking steps and their corresponding one or more inputs. The recipe graph may include a root node associated with the last cooking step to be performed, one or more leaf nodes associated with each of the input ingredients, and one or more other nodes associated with internal cooking results that are used in subsequent cooking steps. In some embodiments, the one or more inputs identified may derive from virtual cooking results associated with one or more intermediate cooking results or virtual cooking results associated with one or more of the one or more leaf nodes.

In step 906, one or more similar recipes associated with the recipe acquired in step 902 are determined. In one embodiment, each of the one or more similar recipes is within a particular flavor distance of the recipe. The particular flavor distance provides a metric for comparing similarities between two different recipes. In one example, the particular flavor distance between the recipe and a second recipe may be based on a difference between one or more taste values associated with the recipe and one or more second taste values associated with the second recipe. In another example, the particular flavor distance between the recipe and a second recipe may also be based on a difference between one or more aromatic values associated with the recipe and one or more second aromatic values associated with the second recipe. In this case, the particular flavor distance between the recipe and the second recipe may be small if both the recipe and the second recipe have many key odorants in common and the corresponding one or more aromatic values are similar. The particular flavor distance between the recipe and a second recipe may also be based on a difference between a total flavor intensity value associated with the recipe and a second total flavor intensity value associated with the second recipe.

In some embodiments, the determination of the particular flavor distance between the recipe and a second recipe may include calculating a first set of differences between one or more taste values associated with the recipe and one or more second taste values associated with the second recipe, calculating a second set of differences between one or more aromatic values associated with the recipe and one or more second aromatic values associated with the second recipe, and calculating a third set of differences between one or more flavor metrics associated with the recipe and one or more second flavor metrics associated with the second recipe. The particular flavor distance may comprise a value associated with the sum of the first set of differences, the second set of differences, and the third set of differences.

In step 908 of FIG. 9A, one or more recipe pairings associated with the recipe are determined. In step 910, one or more similar recipe pairings associated with the one or more similar recipes determined in step 906 are determined. The process of determining one or more recipe pairings in step 908 may be similar to the process of determining one or more similar recipe pairings in step 910. The determining one or more similar recipe pairings may include acquiring one or more user-defined recipe pairings and comparing each of the one or more similar recipes with the recipe pairings within the one or more user-defined recipe pairings. The one or more similar recipe pairings may also be determined using other sources of recipe pairings including classic or well-known recipe pairings and recipe pairings associated with a trusted friend (e.g., as identified via a degree of closeness associated with a social graph or social networking graph). In some cases, the determining one or more similar recipe pairings may also include acquiring one or more user-defined recipe anti-pairings and confirming that each of the one or more similar recipe pairings does not clash with the recipe (i.e., that an anti-pairing between the recipe and one of the one or more similar recipe pairings does not exist). If an anti-pairing exists between the recipe and one of the one or more similar recipe pairings, then the conflicting pairing will not be outputted as one of the one or more similar recipe pairings. In step 912, the one or more recipe pairings determined in step 908 and the one or more similar recipe pairings determined in step 910 are displayed.

In some embodiments, a recipe pair of either the one or more recipe pairings or the one or more similar recipe pairings may be combined in a chewing or mixing cooking step and a virtual cooking result associated with the combined recipe pair may be used to identify other recipe pairings that would go well with the combined recipe pair. In general, any two or more recipes that may be served and/or consumed at the same time may be combined using a chewing cooking step (i.e., a cooking step that simulates the mixing of the two or more recipes during consumption) and a combined virtual cooking result associated with the combined recipes may be generated and compared against, for example, a combined flavor profile associated with a good recipe pairing. In one example, a particular beverage (e.g., a wine or tea) may be identified as a good pairing for the combined recipe pair. In some embodiments, a common paired recipe between the one or more recipe pairings and the one or more similar recipe pairings may be identified and used to promote or rank the common paired recipe over the other recipe pairings.

FIG. 9B is a flowchart describing one embodiment of a process for generating recipe pairings. The process described in FIG. 9B is one example of a process for implementing step 410 in FIG. 4A. In one embodiment, the process of FIG. 9B is performed by a computing device, such as virtual cooking server 150 in FIG. 1.

In step 921, one or more user-defined recipe pairings associated with a particular person are acquired. The one or more user-defined recipe pairings may be part of a personal recipe profile associated with the particular person. In step 922, one or more preferred recipes associated with the particular person are acquired. The one or more preferred recipes may be identified by the particular person communicating a preference for the one or more preferred recipes (e.g., by selecting a “like” button associated with a preferred recipe).

In step 924, one or more other preferred recipes associated with the particular person may be inferred. A preferred recipe of the one or more other preferred recipes may be inferred by identifying a particular recipe in which the amount of time the particular person has spent accessing and/or searching for the particular recipe in an online recipe database is greater than a threshold. A preferred recipe may also be inferred by identifying positive comments or ratings associated with the particular recipe given by the particular person.

In step 925, a first VCR associated with a first recipe of the one or more other preferred recipes is generated. In step 926, one or more similar recipes are determined based on the first VCR generated in step 925. In one embodiment, each of the one or more similar recipes is within a particular flavor distance of the first recipe. In step 927, one or more second recipe pairings associated with a second recipe of the one or more similar recipes are determined. The one or more second recipe pairings may be based on the user-defined recipe pairings acquired in step 921 and the second recipe. In some cases, the one or more second recipe pairings may also be based on classic recipe pairings acquired from a classic recipe pairings database, such as classic pairs and anti-pairs database 361 in FIG. 3F. The one or more second recipe pairings may be determined by comparing each of the one or more similar recipes determined in step 926 with the recipe pairings within the user-defined recipe pairings.

In step 929, a new recipe pairing including the first recipe and a third recipe of the one or more second recipe pairings determined in step 927 is generated. In step 930, the new recipe pairing is displayed.

FIG. 9C is a flowchart describing one embodiment of a process for generating recipe pairings. The process described in FIG. 9C is one example of a process for implementing step 410 in FIG. 4A. In one embodiment, the process of FIG. 9C is performed by a computing device, such as virtual cooking server 150 in FIG. 1.

In step 942, an end user search query is acquired. The end user search query may include one or more recipe constraints such as required food types or required ingredients. In step 944, a plurality of recipe hits based on the end user search query is generated. The plurality of recipe hits may be associated with the most popular recipes stored in a recipe database satisfying the end user search query. In step 946, the plurality of recipe hits are sorted based on a popularity metric. The popularity metric may include user ratings or recipe viewings associated with a particular recipe.

In step 948, a plurality of VCRs associated with the plurality of recipe hits is acquired. The plurality of VCRs may be acquired from a virtual cooking results database, such as VCR database 280 in FIG. 3A. In step 950, a first set of the plurality of recipe hits is determined. In one embodiment, each recipe of the first set is at least a particular flavor distance away from the other recipes of the first set. Thus, each of the recipes of the first set may satisfy the end user search query and consist of different flavor characteristics as compared with the other recipes within the first set.

In step 952, one or more recipe pairings associated with a particular recipe of the first set is determined. The one or more recipe pairings may be determined by comparing the particular recipe with the recipe pairings stored within a classic pairings database, such as classic pairs and anti-pairs database 361 in FIG. 3F. In step 954, the particular recipe and the one or more recipe pairings are displayed.

FIG. 9D is a flowchart describing one embodiment of a process for generating multi-meal recipe recommendations. Multi-meal recipe recommendations may refer to recipe recommendations associated with one or more meals that occur over time and may include multi-course meal recommendations. The process described in FIG. 9D is one example of a process for implementing step 410 in FIG. 4A. In one embodiment, the process of FIG. 9D is performed by a computing device, such as virtual cooking server 150 in FIG. 1.

In step 961, a plurality of recipes is acquired. In step 962, one or more common recipe constraints associated with a plurality of meals are acquired. The plurality of meals may include a first meal and a second meal. In one example, the one or more recipe constraints may include a constraint that each meal of the plurality of meals includes one or more common ingredients (e.g., a particular vegetable or meat). The one or more recipe constraints may also include a constraint on a maximum number of ingredients associated with each meal of the plurality of meals. The one or more recipe constraints may also include nutritional constraints such as a maximum amount of sodium, maximum amount of fat, or minimum amount of fiber associated with each meal of the plurality of meals. The one or more recipe constraints may include a constraint with respect to the maximum amount of time required to cook and prepare each meal of the plurality of meals (e.g., each meal must be ready within one hour). The one or more recipe constraints may include a constraint that each meal of the plurality of meals must pair well with a particular recipe. In some cases, the one or more recipe constraints may include budget constraints such as a maximum meal cost associated with each meal of the plurality of meals or a maximum total meal cost for the plurality of meals (e.g., a maximum weekly food budget).

In step 964, one or more specific recipe constraints associated with the plurality of meals are acquired. In one embodiment, each specific recipe constraint of the plurality of specific recipe constraints applies to a different meal of the plurality of meals. In one example, a specific recipe constraint may require that a particular meal of the plurality of meals be associated with a particular range of total flavor intensity values (e.g., within +/−5% of a particular total flavor intensity value). In another example, a specific recipe constraint may require that a particular meal of the plurality of meals be associated with a particular food type such as a dessert or salad.

FIG. 9E depicts one embodiment of five specific recipe constraints associated with five different meals. Each of the five different meals may correspond with a particular meal time such as breakfast or dinner in a multi-meal scenario. Each of the five different meals may correspond with a particular course in a multi-course scenario where all five meals will be served in the same sitting. As depicted, the five different meals are associated with different times t1-t5. As depicted, the recipe constraints require that the meals associated with times t1, t3, and t5 be assigned a recipe with a total flavor intensity of value centered around 10 units. The meal associated with time t2 must be assigned a recipe with a total flavor intensity value centered around 20 units. The meal associated with time t4 must be assigned a recipe with a total flavor intensity value centered around 30 units.

In step 966 of FIG. 9D, a first set of recipes of the plurality of recipes associated with a first meal of the plurality of meals is determined. In one embodiment, each recipe of the first set of recipes satisfies the one or more common recipe constraints acquired in step 962. Each recipe of the first set of recipes may also satisfy a first specific recipe constraint of the plurality of recipe constraints acquired in step 964.

In step 967, a second set of recipes of the plurality of recipes associated with a second meal of the plurality of meals is determined. In one embodiment, each recipe of the second set of recipes satisfies the one or more common recipe constraints acquired in step 962. Each recipe of the second set of recipes may also satisfy a second specific recipe constraint of the plurality of recipe constraints acquired in step 964.

In step 968, a first recipe of the first set of recipes and a second recipe of the second set of recipes are determined such that the first recipe and the second recipe are separated by at least a particular flavor distance. The first recipe and the second recipe may be determined by acquiring a first virtual cooking result associated with the first recipe, acquiring a second virtual cooking result associated with the second recipe, and comparing the first virtual cooking result with the second virtual cooking result. The particular flavor distance may be based on a difference between taste values associated with the first recipe and the second recipe, a difference between aromatic values associated with the first recipe the second recipe, and/or a difference between total flavor intensity values associated with the first recipe and the second recipe. In step 969, the first recipe and the second recipe are displayed. In some embodiments, one or more recipe pairs may be generated and displayed for each of the multi-meal recipe recommendations. For example, each multi-meal recipe may be paired with a side dish.

In one embodiment, each recipe recommendation of five recipe recommendations associated with a multi-meal scenario (e.g., the five meals are associated with workweek dinner times) satisfies a first common recipe constraint of including chicken as an ingredient and a second common recipe constraint that each recipe includes less than seven ingredients. The specific recipe constraints may require that each of the five recipe recommendations be separated by at least a particular flavor distance. In one example, the particular flavor distance between a first recipe of the five recipe recommendations and a second recipe of the five recommendations may be based on a difference between one or more first aromatic values associated with the first recipe and one or more second aromatic values associated with the second recipe. In another example, the particular flavor distance between a first recipe of the five recipe recommendations and a second recipe of the five recommendations may be based on a maximum number of key odorants in common between the first recipe and the second recipe.

In another embodiment, each recipe recommendation of five recipe recommendations associated with a multi-course scenario (e.g., a five-course dinner) satisfies a set of particular specific recipe constraints corresponding with a particular course number. In one example, the sets of particular specific recipe constraints may require that each multi-course meal fit within a designated range of total flavor intensity values (e.g., within +/−10% of a particular total flavor intensity value). In this multi-course scenario, no common recipe constraints are required.

In one embodiment, the process for generating multi-meal recipe recommendations described in reference to FIG. 9D may be used to generate a plurality of recipe recommendations that may be served and/or consumed at the same time (e.g., during a holiday meal). In one example, a common recipe constraint may require that each recipe of seven recipe recommendations must have less than a threshold level of spiciness. Other recipe constraints may include a first constraint that at most two recipes of the seven recipe recommendations be associated with total flavor intensity values greater than a threshold, a second constraint that at most four recipes of the seven recipe recommendations contain more than a certain percentage of carbohydrates per serving or portion (e.g., a slice of pumpkin pie), and a third constraint that at least three different flavor profiles be satisfied by three recipes of the seven recipe recommendations.

FIG. 9F is a flowchart describing one embodiment of a process for generating recipe recommendations. The process described in FIG. 9F is one example of a process for implementing step 410 in FIG. 4A. In one embodiment, the process of FIG. 9F is performed by a computing device, such as virtual cooking server 150 in FIG. 1.

In step 982, a recipe including a plurality of ingredients is acquired. In step 984, a flavor profile is acquired. The flavor profile may be customized by an end user of a virtual cooking server. In one embodiment, the flavor profile includes one or more target taste values, one or more target aromatic values, and one or more target flavor metrics. One benefit of using a customized or personalized flavor profile is that recipes associated with individualized flavors may be searched for and/or optimized. This capability is beneficial because the flavors perceived with respect to a particular food may vary from person to person due to biological differences or a person's food experiences (e.g., is a person accustomed to eating spicy foods or bland foods).

In some embodiments, a flavor profile may be generated by averaging one or more VCRs stored within a VCR database, such as VCR database 280 in FIG. 3A. The one or more VCRs that are averaged may be determined due to user ratings associated with a common set of one or more VCRs. Each of the VCRs within the common set of one or more VCRs may be associated with a common food type (e.g., biscuits, banana bread, or chocolate cake). In some cases, the flavor profile may be generated using a weighted average of each of the VCRs within the common set of one or more VCRs. For example, if there are seven recipes that are associated with banana bread that have received user ratings of four stars and three recipes that are associated with banana bread that have received user ratings of five stars, then the three recipes receiving the five star ratings will be weighed more heavily than the seven recipes receiving the four star ratings. In one embodiment, the weighted average may be applied to the one or more taste values and the one or more aromatic values associated with each of the VCRs within the common set of one or more VCRs.

In step 986, one or more amounts associated with the plurality of ingredients are determined such that a virtual cooking result associated with the recipe satisfies the flavor profile acquired in step 984. In one embodiment, different virtual cooking results are generated based on different ingredient amounts associated with the plurality of ingredients in order to determine a virtual cooking result that includes taste values close to or matching the one or more target taste values, aromatic values close to or matching the one or more target aromatic values, and flavor metric values close to or matching the one or more target flavor metrics. In some embodiments, the one or more amounts may be used as input variables to a flavor cost function (or objective function) that generates one or more taste values and one or more aromatic values. The flavor cost function may be optimized using various computer optimization techniques such as brute-force or exhaustive techniques, simulated annealing techniques, or linear programming techniques in order to determine an assignment of ingredient amounts for the one or more amounts that satisfies the flavor profile. In step 988, a new recipe based on the one or more amounts is generated. In step 990, the new recipe is displayed.

In some embodiments, a new recipe satisfying a particular flavor profile may be generated using only an initial set of the input ingredients and cooking methods to be used. In this case, an additional set of input ingredients and cooking methods may be determined by considering the input ingredients and cooking methods used by other recipes that are associated with VCRs that provide flavor results similar to the flavor profile. A virtual cooking server may virtually cook a large number of different recipes testing the initial set of input ingredients and cooking methods in addition to the additional set of input ingredients and cooking methods and determine a new recipe that provides a VCR that best matches the particular flavor profile. The ingredient amounts of the initial set of input ingredients and the additional set of input ingredients may be determined by sweeping the ingredient amounts using various step sizes.

FIG. 9G is a flowchart describing one embodiment of a process for generating recipe recommendations. The process described in FIG. 9G is one example of a process for implementing step 410 in FIG. 4A. In one embodiment, the process of FIG. 9G is performed by a computing device, such as virtual cooking server 150 in FIG. 1.

In step 972, a plurality of recipes is acquired. In step 974, a plurality of VCRs associated with the plurality of recipes is generated. In step 976, a flavor profile is acquired. In one embodiment, the flavor profile may include one or more target taste values, one or more target aromatic values, and one or more target flavor metrics. In some cases, the flavor profile may also include one or more mouthfeel values such as a spiciness value. In step 978, a particular recipe of the plurality of recipes that satisfies the flavor profile is identified. In one embodiment, the particular recipe may be identified by acquiring a particular virtual cooking result associated with the particular recipe, comparing one or more taste values associated with the particular virtual cooking result with the one or more target taste values, comparing one or more aromatic values associated with the particular virtual cooking result with the one or more target aromatic values, and comparing one or more flavor metrics associated with the particular virtual cooking result with the one or more target flavor metrics. In another embodiment, the particular recipe may be identified as the recipe with the VCR that best matches the flavor profile within a VCR database. In step 979, the particular recipe is displayed.

One embodiment of the disclosed technology includes acquiring a recipe and generating a virtual cooking result based on the recipe. The virtual cooking result includes one or more flavor metrics. The method further includes generating one or more recipe recommendations based on the one or more flavor metrics and displaying the one or more recipe recommendations.

One embodiment of the disclosed technology includes acquiring a recipe at a virtual cooking server and generating a virtual cooking result based on the recipe using the virtual cooking server. The virtual cooking result includes one or more taste values, one or more aromatic values, and one or more flavor metrics. The method further includes identifying one or more other virtual cooking results stored within a virtual cooking results database based on the virtual cooking result. The one or more other virtual cooking results include a first virtual cooking result associated with a first recipe. The method further includes displaying the first recipe on a mobile device.

One embodiment of the disclosed technology includes a memory and one or more processors. The memory stores a recipe. The one or more processors are in communication with the memory. The one or more processors generate a recipe graph based on the recipe and generate a virtual cooking result based on the recipe. The virtual cooking result includes one or more flavor metrics. The one or more processors generate one or more recipe recommendations based on the one or more flavor metrics.

One embodiment of the disclosed technology includes acquiring a recipe, acquiring one or more recipe pairings, and generating a virtual cooking result based on the recipe. The virtual cooking result includes one or more taste values and one or more aromatic values. The method further includes generating one or more recipe recommendations based on the one or more taste values, the one or more aromatic values, and the one or more recipe pairings and displaying the one or more recipe recommendations.

One embodiment of the disclosed technology includes acquiring a recipe including one or more ingredients and one or more cooking steps, standardizing the one or more ingredients, standardizing the one or more cooking steps, generating a recipe graph based on the one or more ingredients and the one or more cooking steps, and generating a virtual cooking result associated with a root node of the recipe graph. The virtual cooking result includes one or more taste values and one or more aromatic values. The method further includes generating the one or more recipe recommendations based on the one or more taste values and the one or more aromatic values, and displaying the one or more recipe recommendations on a mobile device.

One embodiment of the disclosed technology includes acquiring a recipe including one or more ingredients and one or more cooking steps and generating a virtual cooking result based on the one or more ingredients and the one or more cooking steps. The virtual cooking result includes one or more taste values and one or more aromatic values. The method further includes determining one or more similar recipes. Each of the one or more similar recipes is within a particular flavor distance of the recipe. The method further includes determining one or more similar recipe pairings associated with the one or more similar recipes and displaying at least one of the one or more similar recipe pairings.

One embodiment of the disclosed technology includes a memory in communication with one or more processors. The memory stores one or more user-defined recipe pairings associated with a particular person. The one or more processors infer one or more preferred recipes associated with the particular person, generate a first virtual cooking result associated with a first recipe of the one or more preferred recipes, and determine one or more similar recipes. Each of the one or more similar recipes is within a particular flavor distance of the first recipe. The one or more similar recipes include a second recipe. The one or more processors determine one or more second recipe pairs based on the user-defined recipe pairings and the second recipe. The one or more processors determine a new recipe pairing including the first recipe and a third recipe of the one or more second recipe pairs.

One embodiment of the disclosed technology includes acquiring a search query, generating a plurality of recipes based on the search query, and acquiring a plurality of virtual cooking results associated with the plurality of recipes. The plurality of recipes includes a particular recipe and a second recipe. The particular recipe is associated with a particular virtual cooking result of the plurality of virtual cooking results. The second recipe is associated with a second virtual cooking result of the plurality of virtual cooking results. The method further includes determining a first set of the plurality of recipes including the particular recipe and the second recipe. Each recipe of the first set is at least a particular flavor distance away from the other recipes of the first set. The method further includes determining one or more recipe pairings associated with the particular recipe and displaying the particular recipe and the one or more recipe pairings.

One embodiment of the disclosed technology includes acquiring one or more common recipe constraints associated with a plurality of meals and acquiring a plurality of specific recipe constraints associated with the plurality of meals. Each specific recipe constraint of the plurality of specific recipe constraints applies to a different meal of the plurality of meals. The plurality of meals include a first meal and a second meal. The method further includes acquiring a plurality of recipes and determining a first set of recipes of the plurality of recipes associated with the first meal. Each recipe of the first set of recipes satisfies the one or more common recipe constraints and satisfies a first specific recipe constraint of the plurality of specific recipe constraints. The method further includes determining a second set of recipes of the plurality or recipes associated with the second meal. Each recipe of the second set of recipes satisfies the one or more common recipe constraints and satisfies a second specific recipe constraint of the plurality of specific recipe constraints. The method further includes determining a first recipe of the first set of recipes and a second recipe of the second set of recipes such that the first recipe and the second recipe are separated by at least a particular flavor distance and displaying the first recipe and the second recipe.

One embodiment of the disclosed technology includes acquiring a plurality of recipes and generating a plurality of virtual cooking results associated with the plurality of recipes. Each virtual cooking result of the plurality of virtual cooking results includes a total flavor intensity value. The method further includes acquiring a first set of recipe constraints associated with a first meal. The first set of recipe constraints includes a first range of total flavor intensity values. The method further includes acquiring a second set of recipe constraints associated with a second meal. The second set of recipe constraints includes a second range of total flavor intensity values. The method further includes determining a first set of recipes of the plurality of recipes whereby each recipe of the first set of recipes satisfies the first set of recipe constraints. The method further includes determining a second set of recipes of the plurality of recipes whereby each recipe of the second set of recipes satisfies the second set of recipe constraints and displaying a first recipe of the first set of recipes and a second recipe of the second set of recipes.

One embodiment of the disclosed technology includes acquiring a recipe including a plurality of ingredients, acquiring a flavor profile including one or more target taste values and one or more target aromatic values, and determining one or more amounts associated with the plurality of ingredients such that a virtual cooking result associated with the recipe satisfies the flavor profile. Each of the one or more amounts is associated with a different ingredient of the plurality of ingredients. The determining one or more amounts includes generating the virtual cooking result associated with the recipe using the one or more amounts. The virtual cooking result includes one or more taste values and one or more aromatic values. The determining one or more amounts includes comparing the one or more taste values and the one or more target taste values. The determining one or more amounts includes comparing the one or more aromatic values and the one or more target aromatic values. The method further includes generating a new recipe based on the plurality of ingredients and the one or more amounts and displaying the new recipe.

One embodiment of the disclosed technology includes acquiring a plurality of recipes, generating a plurality of virtual cooking results associated with plurality of recipes, acquiring a flavor profile including one or more target taste values and one or more target aromatic values. The flavor profile also includes a target total flavor intensity value. The method further includes identifying a particular recipe of the plurality of recipes that satisfies the flavor profile. The plurality of virtual cooking results includes a particular virtual cooking result associated with the particular recipe. The particular virtual cooking result includes one or more taste values, one or more aromatic values, and a total flavor intensity value. The method further includes displaying the particular recipe on a mobile device.

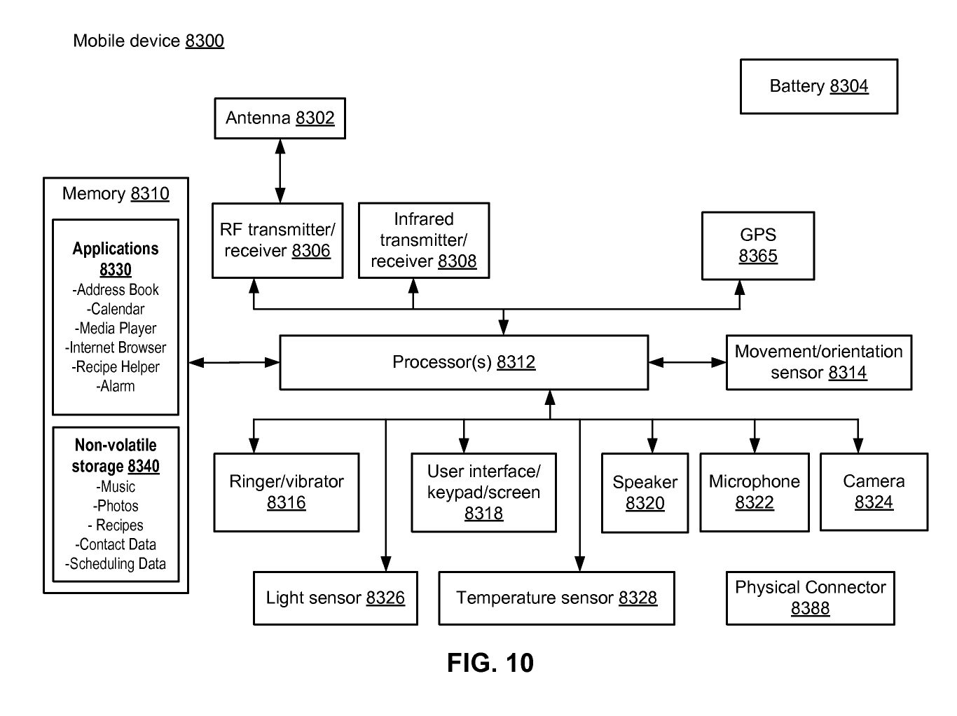

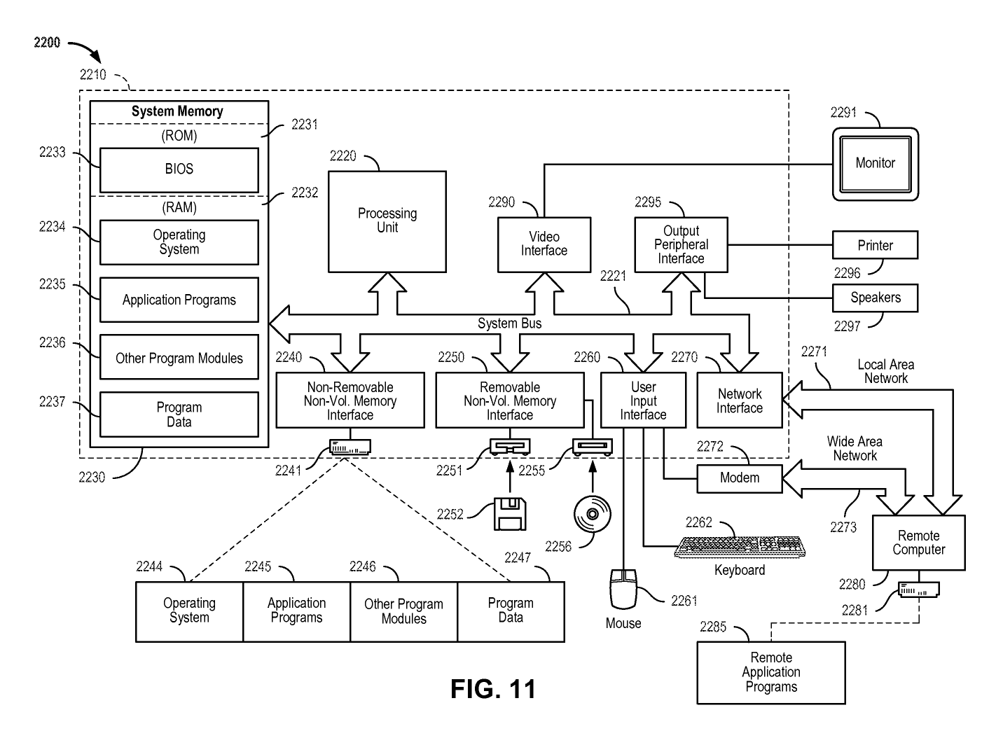

The disclosed technology may be used with various computing systems. FIGS. 10-11 provide examples of various computing systems that can be used to implement embodiments of the disclosed technology.

FIG. 10 is a block diagram of one embodiment of a mobile device 8300, such as mobile device 122 in FIG. 1. Mobile devices may include laptop computers, pocket computers, mobile phones, personal digital assistants, and handheld media devices that have been integrated with wireless receiver/transmitter technology.

Mobile device 8300 includes one or more processors 8312 and memory 8310. Memory 8310 includes applications 8330 and non-volatile storage 8340. Memory 8310 can be any variety of memory storage media types, including non-volatile and volatile memory. A mobile device operating system handles the different operations of the mobile device 8300 and may contain user interfaces for operations, such as placing and receiving phone calls, text messaging, checking voicemail, and the like. The applications 8330 can be any assortment of programs, such as a camera application for photos and/or videos, an address book, a calendar application, a recipe helper application, a media player, an internet browser, games, an alarm application, and other applications. The non-volatile storage component 8340 in memory 8310 may contain data such as music, photos, recipes, contact data, scheduling data, and other files.

The one or more processors 8312 also communicates with RF transmitter/receiver 8306 which in turn is coupled to an antenna 8302, with infrared transmitter/receiver 8308, with global positioning service (GPS) receiver 8365, and with movement/orientation sensor 8314 which may include an accelerometer and/or magnetometer. RF transmitter/receiver 8308 may enable wireless communication via various wireless technology standards such as Bluetooth® or the IEEE 802.11 standards. Accelerometers have been incorporated into mobile devices to enable applications such as intelligent user interface applications that let users input commands through gestures, and orientation applications which can automatically change the display from portrait to landscape when the mobile device is rotated. An accelerometer can be provided, e.g., by a micro-electromechanical system (MEMS) which is a tiny mechanical device (of micrometer dimensions) built onto a semiconductor chip. Acceleration direction, as well as orientation, vibration, and shock can be sensed. The one or more processors 8312 further communicate with a ringer/vibrator 8316, a user interface keypad/screen 8318, a speaker 8320, a microphone 8322, a camera 8324, a light sensor 8326, and a temperature sensor 8328. The user interface keypad/screen may include a touch-sensitive screen display.

The one or more processors 8312 controls transmission and reception of wireless signals. During a transmission mode, the one or more processors 8312 provide voice signals from microphone 8322, or other data signals, to the RF transmitter/receiver 8306. The transmitter/receiver 8306 transmits the signals through the antenna 8302. The ringer/vibrator 8316 is used to signal an incoming call, text message, calendar reminder, alarm clock reminder, or other notification to the user. During a receiving mode, the RF transmitter/receiver 8306 receives a voice signal or data signal from a remote station through the antenna 8302. A received voice signal is provided to the speaker 8320 while other received data signals are processed appropriately.

Additionally, a physical connector 8388 may be used to connect the mobile device 8300 to an external power source, such as an AC adapter or powered docking station, in order to recharge battery 8304. The physical connector 8388 may also be used as a data connection to an external computing device. The data connection allows for operations such as synchronizing mobile device data with the computing data on another device.

FIG. 11 is a block diagram of an embodiment of a computing system environment 2200, such as server 150 in FIG. 1. Computing system environment 2200 includes a general purpose computing device in the form of a computer 2210. Components of computer 2210 may include, but are not limited to, a processing unit 2220, a system memory 2230, and a system bus 2221 that couples various system components including the system memory 2230 to the processing unit 2220. The system bus 2221 may be any of several types of bus structures including a memory bus, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 2210 typically includes a variety of computer readable media. Computer readable media can be any available media that can be accessed by computer 2210 and includes both volatile and nonvolatile media, removable and non-removable media. By way of example, and not limitation, computer readable media may comprise computer storage media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 2210. Combinations of the any of the above should also be included within the scope of computer readable media.

The system memory 2230 includes computer storage media in the form of volatile and/or nonvolatile memory such as read only memory (ROM) 2231 and random access memory (RAM) 2232. A basic input/output system 2233 (BIOS), containing the basic routines that help to transfer information between elements within computer 2210, such as during start-up, is typically stored in ROM 2231. RAM 2232 typically contains data and/or program modules that are immediately accessible to and/or presently being operated on by processing unit 2220. The system memory 2230 may store operating system 2234, application programs 2235, other program modules 2236, and program data 2237.

The computer 2210 may also include other removable/non-removable, volatile/nonvolatile computer storage media. The computer 2210 may include a hard disk drive 2241 that reads from or writes to non-removable, nonvolatile magnetic media, a magnetic disk drive 2251 that reads from or writes to a removable, nonvolatile magnetic disk 2252, and an optical disk drive 2255 that reads from or writes to a removable, nonvolatile optical disk 2256 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 2241 is typically connected to the system bus 2221 through an non-removable memory interface such as interface 2240, and magnetic disk drive 2251 and optical disk drive 2255 are typically connected to the system bus 2221 by a removable memory interface, such as interface 2250.

The drives and their associated computer storage media described above provide storage of computer readable instructions, data structures, program modules and other data for the computer 2210. Hard disk drive 2241 is illustrated as storing operating system 2244, application programs 2245, other program modules 2246, and program data 2247. Note that these components can either be the same as or different from operating system 2234, application programs 2235, other program modules 2236, and program data 2237. Operating system 2244, application programs 2245, other program modules 2246, and program data 2247 are given different numbers here to illustrate that, at a minimum, they are different copies. A user may enter commands and information into computer 2210 through input devices such as a keyboard 2262 and pointing device 2261, commonly referred to as a mouse, trackball, or touch pad. Other input devices (not shown) may include a microphone, joystick, game pad, satellite dish, scanner, or the like. These and other input devices are often connected to the processing unit 2220 through a user input interface 2260 that is coupled to the system bus, but may be connected by other interface and bus structures, such as a parallel port, game port or a universal serial bus (USB). A monitor 2291 or other type of display device is also connected to the system bus 2221 via an interface, such as a video interface 2290. In addition to the monitor, computers may also include other peripheral output devices such as speakers 2297 and printer 2296, which may be connected through an output peripheral interface 2295.

The computer 2210 may operate in a networked environment using logical connections to one or more remote computers, such as a remote computer 2280. The remote computer 2280 may be a personal computer, a server, a router, a network PC, a peer device or other common network node, and typically includes many or all of the elements described above relative to the computer 2210. The logical connections may include a local area network (LAN) 2271 and a wide area network (WAN) 2273, but may also include other networks. Such networking environments are commonplace in offices, enterprise-wide computer networks, intranets and the Internet.

When used in a LAN networking environment, the computer 2210 is connected to the LAN 2271 through a network interface or adapter 2270. When used in a WAN networking environment, the computer 2210 typically includes a modem 2272 or other means for establishing communications over the WAN 2273, such as the Internet. The modem 2272, which may be internal or external, may be connected to the system bus 2221 via the user input interface 2260, or other appropriate mechanism. In a networked environment, program modules depicted relative to the computer 2210, or portions thereof, may be stored in the remote memory storage device. For example, remote application programs 2285 may reside on memory device 2281. It will be appreciated that the network connections shown are exemplary and other means of establishing a communications link between the computers may be used.

The disclosed technology may be operational with numerous other general purpose or special purpose computing system environments. Examples of other computing system environments that may be suitable for use with the disclosed technology include, but are not limited to, personal computers, server computers, hand-held or laptop devices, multiprocessor systems, microprocessor-based systems, programmable consumer electronics, network PCs, minicomputers, mainframe computers, and distributed computing environments that include any of the above systems or devices, and the like.

The disclosed technology may be described in the general context of computer-executable instructions, such as program modules, being executed by a computer. Generally, software and program modules as described herein include routines, programs, objects, components, data structures, and other types of structures that perform particular tasks or implement particular abstract data types. Hardware or combinations of hardware and software may be substituted for software modules as described herein.

The disclosed technology may also be practiced in distributed computing environments where tasks are performed by remote processing devices that are linked through a communications network. In a distributed computing environment, program modules may be located in both local and remote computer storage media including memory storage devices.

For purposes of this document, each process associated with the disclosed technology may be performed continuously and by one or more computing devices. Each step in a process may be performed by the same or different computing devices as those used in other steps, and each step need not necessarily be performed by a single computing device.

For purposes of this document, reference in the specification to “an embodiment,” “one embodiment,” “some embodiments,” or “another embodiment” are used to described different embodiments and do not necessarily refer to the same embodiment.

For purposes of this document, a connection can be a direct connection or an indirect connection (e.g., via another part).

For purposes of this document, the term “set” of objects, refers to a “set” of one or more of the objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for generating multi-meal recipe recommendations, comprising:
acquiring one or more common recipe constraints associated with a plurality of meals, the one or more common recipe constraints apply to each meal of the plurality of meals;
acquiring a plurality of specific recipe constraints associated with the plurality of meals, each specific recipe constraint of the plurality of specific recipe constraints applies to a different meal of the plurality of meals, the plurality of meals include a first meal and a second meal;
acquiring a plurality of recipes;
determining a first set of recipes of the plurality of recipes associated with the first meal, each recipe of the first set of recipes satisfies the one or more common recipe constraints, each recipe of the first set of recipes satisfies a first specific recipe constraint of the plurality of specific recipe constraints;
determining a second set of recipes of the plurality or recipes associated with the second meal, each recipe of the second set of recipes satisfies the one or more common recipe constraints, each recipe of the second set of recipes satisfies a second specific recipe constraint of the plurality of specific recipe constraints;
determining a first recipe of the first set of recipes and a second recipe of the second set of recipes such that the first recipe and the second recipe are separated by at least a particular flavor distance; and
displaying the first recipe and the second recipe.

2. The method of claim 1, wherein:
the determining a first set of recipes is performed by a virtual cooking server;
the determining a second set of recipes is performed by the virtual cooking server;
the determining a first recipe of the first set of recipes and a second recipe of the second set of recipes is performed by the virtual cooking server; and
the determining a first recipe of the first set of recipes and a second recipe of the second set of recipes includes acquiring a first virtual cooking result associated with the first recipe and acquiring a second virtual cooking result associated with the second recipe, the first virtual cooking result includes one or more first taste values, the second virtual cooking result includes one or more second taste values, the determining a first recipe of the first set of recipes and a second recipe of the second set of recipes includes determining a difference between the one or more first taste values and the one or more second taste values.

3. The method of claim 2, wherein:
the particular flavor distance is based on the difference between the one or more first taste values and the one or more second taste values.

4. The method of claim 1, wherein:
the determining a first recipe of the first set of recipes and a second recipe of the second set of recipes includes acquiring a first virtual cooking result associated with the first recipe and acquiring a second virtual cooking result associated with the second recipe, the first virtual cooking result includes one or more first aromatic values, the second virtual cooking result includes one or more second aromatic values, the determining a first recipe of the first set of recipes and a second recipe of the second set of recipes includes determining a difference between the one or more first aromatic values and the one or more second aromatic values.

5. The method of claim 4, wherein:
the particular flavor distance is based on the difference between the one or more first aromatic values and the one or more second aromatic values.

6. The method of claim 1, wherein:
the determining a first recipe of the first set of recipes and a second recipe of the second set of recipes includes acquiring a first virtual cooking result associated with the first recipe and acquiring a second virtual cooking result associated with the second recipe, the first virtual cooking result includes a first total flavor intensity value, the second virtual cooking result includes a second total flavor intensity value, the determining a first recipe of the first set of recipes and a second recipe of the second set of recipes includes determining a difference between the first total flavor intensity value and the second total flavor intensity value.

7. The method of claim 6, wherein:
the particular flavor distance is based on the difference between the first total flavor intensity value and the second total flavor intensity value.

8. The method of claim 1, wherein:
the one or more common recipe constraints include a constraint that each meal of the plurality of meals includes one or more common ingredients.

9. The method of claim 8, wherein:
the one or more common ingredients include at least one of a particular vegetable or a particular meat.

10. The method of claim 1, wherein:
the one or more common recipe constraints include a constraint on a maximum number of ingredients.

11. The method of claim 1, wherein:
the first specific recipe constraint includes a first range of total flavor intensity values; and
the second specific recipe constraint includes a second range of total flavor intensity values different from the first range of total flavor intensity values.

12. The method of claim 1, wherein:
the first specific recipe constraint includes a first range of one or more aromatic values; and
the second specific recipe constraint includes a second range of one or more aromatic values different from the first range of one or more aromatic values.

13. The method of claim 1, wherein:
the first meal is associated with a first point in time and the second meal is associated with a second point in time subsequent to the first point in time.

14. A system for generating multi-meal recipe recommendations, comprising:
a memory, the memory stores a plurality or recipes, the memory stores one or more common recipe constraints associated with a plurality of meals, the one or more common recipe constraints apply to each meal of the plurality of meals, the memory stores a plurality of specific recipe constraints associated with the plurality of meals, each specific recipe constraint of the plurality of specific recipe constraints applies to a different meal of the plurality of meals, the plurality of meals include a first meal and a second meal; and
one or more processors, the one or more processors in communication with the memory, the one or more processors determine a first set of recipes of the plurality of recipes associated with the first meal, each recipe of the first set of recipes satisfies the one or more common recipe constraints, each recipe of the first set of recipes satisfies a first specific recipe constraint of the plurality of specific recipe constraints, the one or more processors determine a second set of recipes of the plurality or recipes associated with the second meal, each recipe of the second set of recipes satisfies the one or more common recipe constraints, each recipe of the second set of recipes satisfies a second specific recipe constraint of the plurality of specific recipe constraints, the one or more processors determine a first recipe of the first set of recipes and a second recipe of the second set of recipes such that the first recipe and the second recipe are separated by at least a particular flavor distance.

15. A method for generating multi-meal recipe recommendations, comprising:
acquiring a plurality of recipes;
generating a plurality of virtual cooking results associated with the plurality of recipes, each virtual cooking result of the plurality of virtual cooking results includes a total flavor intensity value;
acquiring a first set of recipe constraints associated with a first meal, the first set of recipe constraints includes a first range of total flavor intensity values;
acquiring a second set of recipe constraints associated with a second meal, the second set of recipe constraints includes a second range of total flavor intensity values;
determining a first set of recipes of the plurality of recipes, each recipe of the first set of recipes satisfies the first set of recipe constraints;
determining a second set of recipes of the plurality of recipes, each recipe of the second set of recipes satisfies the second set of recipe constraints; and
displaying a first recipe of the first set of recipes and a second recipe of the second set of recipes.

16. The method of claim 15, wherein:
the generating a plurality of virtual cooking results is performed by a virtual cooking server;
the determining a first set of recipes is performed by the virtual cooking server;
the determining a second set of recipes is performed by the virtual cooking server; and
the determining a first set of recipes includes comparing each total flavor intensity value associated with each of the plurality of recipes with the first range of total flavor intensity values.

17. The method of claim 16, wherein:
the determining a second set of recipes includes comparing each total flavor intensity value associated with each of the plurality of recipes with the second range of total flavor intensity values.

18. The method of claim 15, wherein:
the first recipe includes a first ingredient and the second recipe includes the first ingredient.

19. The method of claim 15, wherein:
the first recipe includes less than a particular number of ingredients and the second recipe includes less than the particular number of ingredients.

20. The method of claim 15, wherein:
the first meal is associated with a first point in time and the second meal is associated with a second point in time subsequent to the first point in time.
